(19) United States
(12) Patent Application Publication
(10) Pub. No.: US 2020/0095367 A1
(43) Pub. Date: Mar. 26, 2020

(54) URETHANE METHACRYLATE COMPOUNDS AND USE THEREOF

(71) Applicant: Hilti Aktiengesellschaft, Schaan (LI)

(72) Inventors: Georg Nickerl, Diessen am Ammersee (DE); Beate Gnass, Gersthofen (DE); Natja Park, Muenchen (DE); Jens Bunzen, Augsburg (DE); Klaus Schaefers, Kaufering (DE); Ralf Neuerburg, Augsburg (DE); Rainer Strobel-Schmidt, Bad Woerishofen (DE); Gerald Gaefke, Augsburg (DE)

(73) Assignee: Hilti Aktiengesellschaft, Schaan (LI)

(21) Appl. No.: 16/613,146

(22) PCT Filed: Jun. 19, 2018
(86) PCT No.: PCT/EP2018/066243

§ 371 Date: Nov. 13, 2019

(30) Foreign Application Priority Data
Jul. 3, 2017 (EP) 17179287.2

(51) Int. Cl. C08G 18/62; C08F 222/22; C08G 18/67; C08G 18/76; C09J 175/14; C09J 11/04; C09J 5/00

(52) U.S. Cl. CPC C08G 18/6283; C08F 222/22; C08G 18/6755; C08G 18/7614; C09J 2483/00; C09J 11/04; C09J 5/00; C09J 2203/102; C09J 2475/00; C09J 175/14

(57) ABSTRACT

Low-viscosity urethane methacrylate compounds are used as a backbone resin in reactive resins. In particular, the compounds are for lowering the viscosity of reactive resins containing such mixtures and thus the extrusion forces of reactive resin components produced therefrom and also for increasing the performance of reactive resins and reactive resin components produced therefrom containing such compounds. Furthermore, said compounds and their reactive resin components are used for construction purposes, in particular for chemical fastening.

The invention relates to low-viscosity urethane methacrylate compounds as backbone resins, and to the use thereof in reactive resins, especially for lowering the viscosity of reactive resins containing such compounds and thus the forces for extruding reactive-resin components produced therefrom. Furthermore, the invention relates to the use of these reactive resins and of their reactive-resin components for construction purposes, especially for chemical fastening.

The free-radical-curing fastening caulks currently in use are based on unsaturated polyesters, vinyl ester urethane resins and epoxy acrylates. These are mostly two-component reactive-resin systems, wherein one component is the resin (known as component (A)) and the other component (component (B)) contains the curing agent. Further ingredients such as inorganic fillers and additives, accelerators, stabilizers and reactive diluents may be contained in the one and/or the other component. By mixing the two components, the curing of the mixed components is initiated. During use of the fastening caulks for fastening of anchoring elements in drilled holes, the curing takes place in the drilled holes.

Such a fastening caulk is known, for example, from DE 3940138 A1. This describes fastening caulks on the basis of monomers that carry cycloaliphatic groups and may additionally contain unsaturated polyester or vinyl ester resins. Such fastening caulks have relatively high viscosities, however, whereby their use use is limited, especially for the chemical fastening technique.

Relatively broad temperature ranges, from −25° C. to +45° C., for example, can occur on construction sites, depending on time of year and/or geographic location. Therefore not only the high viscosity of the curable fastening caulks described in the introduction but also their resulting thixotropic behavior during application can lead to problems. Therefore the area of use of such fastening caulks is subject to great demands, especially for use in various temperature ranges.

On the one hand, a sufficiently low viscosity of the caulk that it can be extruded should be ensured in the low-temperature range, so that the flow resistance of the caulk is not too high. Thus it should be ensured that the caulks can be injected, for example into the drilled hole, using a hand dispenser, for example. In particular, during the use of static mixers, a low viscosity is of importance for flawless mixing of the two components.

On the other hand, the caulk should be sufficiently stable in the higher temperature range, so that continued running of the individual components after release of pressure on the dispenser is prevented and that the caulk does not leak out of the drilled hole during overhead installation.

A further problem caused by temperature fluctuations is that the free-radical chain polymerization does not take place uniformly. Thus the cured fastening caulk has fluctuating/irregular and frequently inadequate homogeneity, which is manifested in fluctuations of the load ratings and frequently also in generally low load ratings. For example, at temperatures below 20° C., premature setting of the fastening caulk may occur due to an increase of the viscosity. Thereby the conversion in the free-radical chain polymerization is substantially smaller, thus contributing to a reduction of the load ratings.

Since temperature fluctuations on the construction site cannot be avoided, a need continues to exist for two-component reactive-resin systems that ensure homogeneity both at high and at low temperatures as well as reproducibility of the load ratings associated therewith.

In order to address the foregoing problems, the proportion of reactive diluents in the fastening caulks available on the market is increased, ultimately leading to reduction of the resin proportion in the caulk. Not uncommonly, the proportion of reactive diluents amounts to at least 50% relative to the reactive resin.

However, the increase of the proportion of reactive diluents also leads to some disadvantages, which become evident above all during application of the fastening caulk for fastening of anchoring means in drilled holes.

A considerable disadvantage is that the reduction of the proportion of highly viscous resin, which is essential for the performance capability of the caulk, negatively influences the performance capability of the cured fastening caulk.

A further disadvantage is greater shrinkage of the fastening caulk after curing, which may additionally influence the performance capability of the cured fastening caulk negatively. This is attributed to the fact that the contact between the cured fastening caulk and the undercuts, formed in the wall of the drilled hole during creation of the drilled hole, which become apparent in particular during use of percussion drills, is significantly reduced. This usually also prevents application of fastening caulks based on free-radical-curing compounds in diamond-drilled holes.

A further disadvantage is that, depending on type of reactive diluent, the proportion of volatile organic compounds (VOC) in the caulks may increase. This may lead to evaporation from the fastening caulk and/or the canister and possibly to a drop in performance of the cured fastening caulk that results from this. In addition, some of these compounds may also be hazardous to health and/or are therefore subject to mandatory labeling.

In addition, the number of usable reactive diluents is small, since only few available reactive diluents are on the market at present. Other than the free-radical-curing functional groups, the available reactive diluents have no or only a very limited choice of other functional groups and therefore often have only little influence on the property of the cured fastening caulk. This leads to the situation that the fastening caulks are being developed mostly for specific applications, such as certain temperature ranges, for example, or for application in specific substrates. This calls for an immense development effort in order to be able to address new and broader applications with the fastening caulks.

Heretofore special products have been produced, the formulations of which are adapted to the special application temperatures. Products indeed exist that are intended for a broad temperature range while still having the same properties over the entire range. Precisely in the boundary ranges, i.e. at low and at high temperatures, impairments must be expected either in processability, in curing of the caulk or in the properties of the cured caulk. No fastening caulk is known that covers a very broad temperature range without having to tolerate losses in the boundary ranges.

A need therefore exists for fastening caulks having performance capability and properties capable of being influenced not by the use of reactive diluents but instead by the resin ingredient.

One object of the present invention is to influence the properties of a reactive-resin master batch as well as of a reactive resin produced therefrom in a manner attributable solely to the structure of the backbone resin but not to the presence of additional compounds, such as reactive diluents or additives, for example. Mainly, the object of the present invention is to control the properties of a two-component or multi-component reactive-resin system by means of the backbone resin it contains. In particular, it is an object of the present invention to provide fastening caulks, such as two-component or multi-component reactive-resin systems, for example, the viscosity of which depends less on the temperature of application of the fastening caulk, which have a low viscosity, especially at low temperatures, such as below 20° C., for example, and thus make it possible to supply reactive-resin systems, which have smaller extrusion forces at application temperatures below 20° C., especially at application temperatures below 10° C., and thus are more user-friendly than the conventional fastening systems.

A further object of the invention is to provide a fastening caulk that has lower forces to extrude the reactive-resin component and at the same time achieves higher load ratings of the cured fastening caulk than do conventional caulks.

Yet another object of the present invention is to provide a fastening caulk that avoids constituents posing a serious health hazard in the reactive-resin component and that optionally is also exempt from labeling. In particular, it is an object to reduce the proportion of reactive diluents in reactive resins for chemical fastening, without having to sacrifice their function or functions and positive effects on the cured fastening caulk.

Yet another object of the present invention is to provide a fastening caulk that is distinguished by good processability, curing behavior and small shrinkage over a broad temperature range.

These objects are solved by the compounds according to claim 1 and the use thereof according to claims 5 and 8, by the reactive resin according to claim 9 and by the reactive-resin component according to claim 10.

Surprisingly, it has been found that, due to the use of certain low-viscosity urethane methacrylate compounds as backbone resin, a broad temperature range is achieved in which the viscosity of a reactive resin containing these compounds and of a reactive-resin component obtainable therefrom remains largely uninfluenced by the temperatures.

Advantageously, the present invention permits, in comparison with the conventional systems, low extrusion forces at low application temperatures in a reactive-resin system. Due to the use of low-viscosity urethane methacrylate compounds as backbone resin in reactive resins, it has therefore become possible to reduce the forces for extruding a reactive-resin system not only at 20° C. but also at lower temperatures, for example at temperatures below 10° C., preferably below 5° C., without requiring a high proportion of reactive diluent for the purpose.

Furthermore, it has been found that it is possible, due to the use of certain low-viscosity urethane methacrylate compounds, to reduce the proportion of reactive diluents in reactive resins for chemical fastening, without having to sacrifice their function or functions and positive effects on the cured fastening caulk, since the proportion of backbone resin can be increased. Hereby it is possible on the one hand to increase the load ratings of a cured caulk, and on the other hand to achieve higher load ratings at higher temperatures, for example at 80° C., with the same proportion of backbone resin.

The invention is based on the knowledge that it is possible to replace the higher-viscosity resins used heretofore in fastening caulks by smaller, low-viscosity backbone resins, in order to lower the proportion of reactive diluents without having to sacrifice their functionality.

For better understanding of the invention, the following explanations of the reactive-resin production method and of the terminology used herein are considered to be useful.

The reactive-resin production method, explained here by means of the example of an MDI-based urethane methacrylate, typically takes place as follows:

### 1. Production of Backbone-Resin/Reactive-Resin Master Batch

Methane diphenyl diisocyanate (MDI) and hydroxypropyl methacrylate (HPMA) are reacted in the presence of a catalyst and of an inhibitor (used to stabilize the backbone resin formed by the polymerization, and frequently also called stabilizer or process stabilizer). In this process, the backbone resin is obtained.

The reaction mixture obtained after the end of the reaction is known as reactive-resin master batch. This is not worked up further, i.e. the backbone resin is not isolated.

### 2. Production of Reactive Resin

After completion of the reaction to the backbone resin, an accelerator-inhibitor system, i.e. a combination of one or more additional inhibitors and one or more accelerators and optionally a reactive diluent, is added to the reactive-resin master batch.

Hereby the reactive resin is obtained.

The accelerator-inhibitor system is used to adjust the reactivity of the reactive resin, i.e. to adjust the point in time up to which the reactive resin has not yet cured completely after addition of an initiator and up to which point in time a plugging caulk mixed in with the reactive resin therefore remains processable after mixing with the initiator.

The inhibitor in the accelerator-inhibitor system may be identical to the inhibitor for the production of the backbone resin, provided this is also suitable for adjusting the reactivity, or it may be a different inhibitor if it does not possess both functions. As an example, 4-hydroxy-2,2,6,6-tetramethyl-piperidinyl-1-oxyl (TEMPOL) may be used as stabilizer and as inhibitor for adjustment of the reactivity.

### 3. Production of Reactive-Resin Component

In order to use the reactive resin for construction purposes, especially for chemical fastening, one or more inorganic aggregates, such as additives and/or fillers, are added after production of the reactive resin.

Hereby the reactive-resin component is obtained.

Within the meaning of the invention, the terms used:
“backbone resin” means a usually solid or highly viscous free-radical-curing polymerizable resin, which cures by polymerization (e.g. after addition of an initiator in the presence of an accelerator) and as a rule exists without reactive diluent and without further purification and thus may contain impurities;
“reactive-resin master batch” means the reaction product of the reaction for production of the backbone resin, i.e. a mixture of backbone resin, reactive diluent and optionally further ingredients of the reaction mixture;
“reactive resin” means a mixture of reactive-resin master batch, at least one accelerator and at least one inhibitor (also referred to as accelerator-inhibitor system), at least one reactive diluent and optionally further additives; the reactive resin is typically liquid or viscous and may be further processed to a reactive-resin component; herein, the reactive resin is also referred to as “resin mixture”;
“inhibitor” means a substance that suppresses an undesired free-radical polymerization during the synthesis or storage of a resin or of a resin-containing composition (these substances are also referred to in professional circles as “stabilizer”) or that causes a time delay of free-radical polymerization of a resin after addition of an initiator (usually in conjunction with an accelerator) (these substances are also referred to in professional circles as “inhibitor”—the respective meaning of the term is apparent from the context);
“accelerator” means a reagent that participates with the initiator in a reaction, so that larger quantities of free radicals are already generated by the initiator at low temperatures, or that catalyzes the decomposition reaction of the initiator;
“reactive diluent” means liquid or low-viscosity monomers and backbone resins, which dilute other backbone resins or the reactive-resin master batch and thereby impart the necessary viscosity for application thereof, which contain functional groups capable of reaction with the backbone resin and during polymerization (curing) become largely an ingredient of the cured caulk (e.g. of the mortar); reactive diluents are also called co-polymerizable monomers;
“reactive-resin component” means a liquid or viscous mixture of reactive resin and fillers as well as optionally further components, e.g. additives; typically, the reactive-resin component is one of the two components of a two-component reactive-resin system for chemical fastening;
“initiator” means a substance that forms reaction-initiating free radicals (usually in combination with an accelerator);
“hardener component” means a composition that contains an initiator for polymerization of a backbone resin; the hardener component may be solid or liquid and besides the initiator may contain a solvent as well as fillers and/or additives; typically, the hardener component in addition to the reactive-resin component is the other of the two components of a two-component reactive-resin system for chemical fastening;
“mortar caulk/fastening caulk” means the composition that is obtained by mixing the reactive-resin component with the hardener component and that may be used directly as such for chemical fastening;
“reactive-resin system” generally means a system that comprises components stored separately from one another, so that curing of the backbone resin contained in one component takes place only after mixing of the components;
“two-component system” or “two-component reactive-resin system” means a reactive-resin system that comprises two components stored separately from one another, a reactive-resin component (A) and a hardener component (B), so that curing of the backbone resin contained in the reactive-resin component takes place only after mixing of the two components;
“multi-component system” or “multi-component reactive-resin system” means a reactive-resin system that comprises several components stored separately from one another, including, among other possibilities, a reactive-resin component (A) and a hardener component (B), so that curing of the backbone resin contained in the reactive-resin component takes place only after mixing of all components;
“construction purposes” means any application for creation and maintenance or repair of building parts and building structures, as a polymer concrete, as a plastic-based coating caulk or as a cold-curing road marking; in particular, the reinforcement of building parts and building structures, for example walls, ceilings or floors, the fastening of building parts, such as panels or blocks, for example of stone, glass or plastic, on building parts or building structures, for example by adhesive bonding (constructional adhesive bonding) and quite particularly chemical fastening of anchoring means, such as anchor rods, bolts or the like in recesses, such as drilled holes;
“chemical fastening” means fastening (by substance-to-substance and/or interlocking joining) of anchoring means, such as anchor rods, bolts, rebars, screws or the like in recesses, such as drilled holes, especially in holes drilled in various substrates, especially mineral substrates, such as those on the basis of concrete, cellular concrete, brickwork, lime sandstone, sandstone, natural rock, glass and the like, and metallic substrates, such as those of steel;
“aromatic hydrocarbon group” means a cyclic, planar hydrocarbon group having an aromatic system, which on the basis of its delocalized electron system is energetically more favorable and therefore chemically more stable than its non-aromatic mesomers (PAC, 1995, 67, 1307; Glossary of class names of organic compounds and reactivity intermediates based on structure (IUPAC Recommendations 1995) page 1319);
“aromatic diisocyanate” means that the two isocyanate groups are bound directly to an aromatic hydrocarbon skeleton;
“(meth)acryl . . . / . . . (meth)acryl . . . ” means that both the “methacryl . . . / . . . methacryl . . . ” and the “acryl . . . / . . . acryl . . . ” compounds are intended; preferably, “methacryl . . . / . . . methacryl . . . ” compounds are intended in the present invention;
“a”, “an”, “any”, as the indefinite article preceding a class of chemical compounds, e.g. preceding the word “urethane methacrylate”, means that at least one, i.e. one or more compounds included under this class of chemical compounds, e.g. various urethane methacrylates, may be intended. In a preferred embodiment, only one individual compound is intended with this indefinite article;
“at least one” means numerically “one or more”. In a preferred embodiment, “a”, “an”, “any” is meant numerically with this term;
“contain” and “comprise” mean that still further ingredients may be present in addition to those mentioned. These terms are intended to be inclusive and therefore also encompass “consist of”. “Consist of” is intended conclusively and means that no further ingredients may be present. In a preferred embodiment, the terms “contain” and “comprise” mean the term “consist of”;
“approximately” or “circa” preceding a numerical value mean a range of ±5% of this value, preferably ±2% of this value, more preferably ±1% of this value, particularly preferably ±0% of this value (i.e. exactly this value);
a range limited by numbers means that the two extreme values and any value within this range are disclosed individually.

All standards cited in this text (e.g. DIN standards) were used in the version that was current on the date of filing of this Application.

A first subject matter of the invention is a compound of general formula (I)

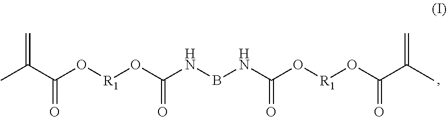

in which
B is an aromatic hydrocarbon group, and
each R₁, independently of one another, is a branched or linear aliphatic C₁-C₁₅ alkylene group.

A second subject matter is the use thereof for production of a reactive resin or a reactive-resin component for construction purposes. A third subject matter is the use thereof for lowering the viscosity of a reactive resin or for reducing the forces for extruding a reactive-resin component or a reactive-resin system for construction purposes. A fourth subject matter is the use thereof for increasing the load ratings of a cured fastening caulk. A fifth subject matter is a reactive resin comprising the compound of general formula (I), an inhibitor, an accelerator and optionally a reactive diluent. A sixth subject matter is a reactive-resin component for a reactive-resin system comprising the reactive resin. A seventh subject matter is a reactive-resin system, having the reactive-resin component and a hardener component, which contains an initiator. An eighth subject matter is the use of the reactive resin or of the reactive-resin system for construction purposes.

According to the invention, the low-viscosity urethane methacrylate compound is a compound of general formula (I)

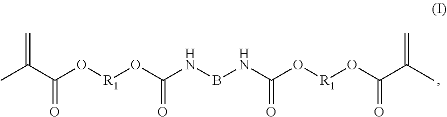

in which B is an aromatic hydrocarbon group, and each R₁, independently of one another, is a branched or linear aliphatic C₁-C₁₅ alkylene group.

The aromatic hydrocarbon group is divalent and preferably has 6 to 20 carbon atoms and more preferably 6 to 14 carbon atoms. The aromatic hydrocarbon group may be substituted, especially by alkyl moieties, among which alkyl moieties having one to four carbon atoms are preferred.

In one embodiment, the aromatic hydrocarbon group contains a benzene ring, which may be substituted.

In an alternative embodiment, the aromatic hydrocarbon group contains two condensed benzene rings or two benzene rings bridged via an alkylene group, such as a methylene or ethylene group. Both the benzene rings and the alkylene bridges may be substituted, preferably with alkyl groups.

The aromatic hydrocarbon group is derived from aromatic diisocyanates, wherein “aromatic diisocyanate” means that the two isocyanate groups are bound directly to an aromatic hydrocarbon skeleton.

Suitable aromatic hydrocarbon groups are divalent groups, such as are obtained by removal of the isocyanate groups from an aromatic diisocyanate, for example a divalent phenylene group from a benzene diisocyanate, a methylphenylene group from a toluene diisocyanate (TDI) or an ethylphenylene group from an ethylbenzene diisocyanate, a divalent methane diphenylene group from a methane diphenyl diisocyanate (MDI) or a divalent naphthyl group from a naphthalene diisocyanate (NDI).

Particularly preferably, B is derived from 1,3-diisocyanatobenzene, 1,4-diisocyanatobenzene, 2,4-diisocyanatotoluene, 2,6-diisocyanatotoluene, 2,4′-diphenylmethane diisocyanate, 4,4′-diphenylmethane diisocyanate or 1,5-diisocyanatonaphthalene.

R₁, respectively independently of one another, is a branched or linear aliphatic C₁-C₁₅ alkylene group, which may be substituted. R₁ is derived from hydroxyalkyl methacrylates and comprises divalent alkylene groups, such as are obtained by removal of the hydroxyl groups and of the methacrylate group.

In one embodiment, the alkylene group R₁ is divalent.

In an alternative embodiment, however, it may also be trivalent or polyvalent, so that the compound of formula (I) may also have more than two methacrylate groups, even if this is not directly apparent from formula (I).

Preferably, the alkylene group R₁ is a divalent linear or branched C₁-C₁₅ alkylene group, preferably a C₁-C₆ alkylene group and particularly preferably a C₁-C₄ alkylene group. These include in particular the methylene, ethylene, propylene, i-propylene, n-butylene, 2-butylene, sec.-butylene, tert.-butylene, n-pentylene, 2-pentylene, 2-methylbutylene, 3-methylbutylene, 1,2-dimethylpropylene, 1,1-dimethylpropylene, 2,2-dimethylpropylene, 1-ethylpropylene, n-hexylene, 2-hexylene, 2-methylpentylene, 3-methylpentylene, 4-methylpentylene, 1,2-dimethylbutylene, 1,3-dimethylbutylene, 2,3-dimethylbutylene, 1,1-dimethylbutylene, 2,2-dimethylbutylene, 3,3-dimethylbutylene, 1,1,2-trimethylpropylene, 1,2,2-trimethylpropylene, 1-ethylbutylene, 2-ethylbutylene, 1-ethyl-2-methylpropylene, n-heptylene, 2-heptylene, 3-heptylene, 2-ethylpentylene, 1-propylbutylene groups or the octylene group, among which the ethylene, propylene and isopropylene groups are more preferred. In a particularly preferred embodiment of the present invention, the two R₁ groups are identical and are an ethylene, propylene or i-propylene group.

The inventive low-viscosity urethane methacrylate compounds are obtained by reaction of two equivalents of hydroxyalkyl methacrylate with at least one equivalent of diisocyanate. The diisocyanate and the hydroxyalkyl methacrylate are made to react in the presence of a catalyst and of an inhibitor, which acts to stabilize the resulting compound.

Suitable hydroxyalkyl methacrylates are such with alkylene groups having up to 15 carbon atoms, wherein the alkylene groups may be linear or branched. Hydroxyalkyl methacrylates having 1 to 10 carbon atoms are preferred. More preferred hydroxyalkyl methacrylates are such with two to six carbon atoms, among which 2-hydroxyethyl methacrylate, 2-hydroxypropyl methacrylate (2-HPMA), 3-hydroxypropyl methacrylate (3-HPMA) and glycerol 1,3-dimethacrylate are particularly preferred. 2-Hydroxypropyl methacrylate (2-HPMA) or 3-hydroxypropyl methacrylate (3-HPMA) are quite particularly preferred.

Preferred aromatic diisocyanates are such with aromatically bound isocyanate groups, such as diisocyanatobenzene, toluene diisocyanates (TDI), diphenylmethane diisocyanates (MDI), diisocyanatonaphthalenes. These compounds may exist in different compositions both as pure compounds and as optical isomers or as isomer mixtures, which optionally may be separated in conventional manner.

Particularly preferred aromatic diisocyanates are 1,4-diisocyanatobenzene, 2,4-diisocyanatotoluene, 2,6-diisocyanatotoluene, 2,4′-diphenylmethane diisocyanate, 4,4′-diphenylmethane diisocyanate and 1,5-diisocyanatonaphthalene.

Preferably, the compound of formula (I) is a compound of general formula (II) or (III)

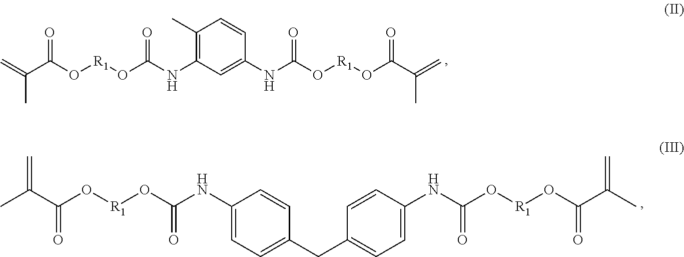

in which each R₁, independently of one another, is as defined hereinabove.

Quite particularly preferably, the compound of formula (I) is a compound of formula (IV) or (V):

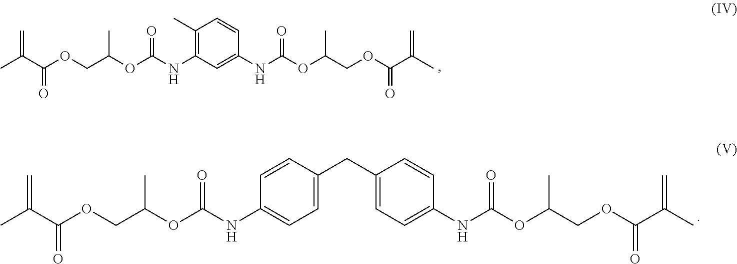

The structures shown in formulas (I), (II), (III), (IV) and (V) are intended to represent only examples of the inventive compounds, since the diisocyanates used for the production thereof may be used both as isomerically pure compounds and as mixtures of the different isomers, in respectively different compositions, i.e. in different quantitative ratios. The structures shown are therefore not to be construed as limitative.

Consequently, the inventive compounds are able to exist as isomerically pure compounds or as isomer mixtures, in different compositions, which optionally may be separated in conventional manner. Both the pure isomers and the isomer mixtures are subject matter of the present invention. Mixtures containing different proportions of isomeric compounds are also subject matter of the invention.

For the case that not all isocyanate groups are converted during production of the inventive compounds, or that some of the isocyanate groups are converted to other groups prior to the reaction, for example by a side reaction, compounds are obtained which may be contained either as main compounds or as impurities in the reactive-resin master batch. To the extent that these compounds may be used for the inventive purposes, they are also comprised by the invention.

The compounds of formula (I) are used according to the invention for production of a reactive resin. Hereby the viscosity of the reactive resin produced in this way may be lowered, without the need for a high proportion of reactive diluents, as is the case for commercial caulks, and without the problems associated with a high proportion of reactive diluents, such as, for example, reduction of the attainable load ratings of the cured caulk. Thus reduction of the forces for extruding a reactive-resin system containing the inventive compounds can be achieved. Furthermore, the load ratings of a cured fastening caulk may be increased by the use of the inventive compounds.

The inventive reactive resin contains a compound of formula (I) as described hereinabove as a backbone resin, an inhibitor, an accelerator and optionally a reactive diluent. Since the backbone resin, after its production, is typically used without isolation for production of the reactive resin, further ingredients, such as a catalyst, for example, contained in the reactive-resin master batch, are usually still also present in the reactive resin, besides the backbone resin.

The proportion of the compound of general formula (I) in the inventive reactive resin ranges from 25 wt % to 65 wt %, preferably from 30 wt % to 45 wt %, particularly preferably from 35 wt % to 40 wt %, quite particularly preferably from 33 wt % to 40 wt % relative to the total weight of the reactive resin.

The stable free radicals that are commonly used for free-radical-curing polymerizable compounds, such as N-oxyl free radicals, as are known to the person skilled in the art, are suitable as inhibitors.

The inhibitor may function on the one hand to suppress undesired free-radical polymerization during synthesis of the backbone resin or during storage of the reactive resin and of the reactive-resin component. It may also function—optionally additionally—to cause a time delay of the free-radical polymerization of the backbone resin after addition of the initiator, and thereby to adjust the processing time of the reactive resin or of the reactive-resin component after mixing with the curing agent.

As examples of stable N-oxyl free radicals, such may be used as described in DE 199 56 509 A1 and DE 195 31 649 A1. Such stable nitroxyl free radicals are of the piperidinyl-N-oxyl or tetrahydropyrrole-N-oxyl type or a mixture thereof.

Preferred stable nitroxyl free radicals are selected from the group consisting of 1-oxyl-2,2,6,6-tetramethylpiperidine, 1-oxyl-2,2,6,6-tetramethylpiperidine-4-ol (also known as TEMPOL), 1-oxyl-2,2,6,6-tetramethylpiperidine-4-one (also known as TEMPON), 1-oxyl-2,2,6,6-tetramethyl-4-carboxyl-piperidine (also known as 4-carboxy-TEMPO), 1-oxyl-2,2,5,5-tetramethylpyrrolidine, 1-oxyl-2,2,5,5-tetramethyl-3-carboxylpyrrolidine (also known as 3-carboxy-PROXYL) and mixtures of two or more of these compounds, wherein 1-oxyl-2,2,6,6-tetramethylpiperidine-4-ol (TEMPOL) is particularly preferred. The TEMPOL is preferably the TEMPOL used in the examples.

Besides the nitroxyl free radical of the piperidinyl-N-oxyl or tetrahydropyrrole-N-oxyl type, one or more further inhibitors may be present not only for further stabilization of the reactive resin or of the reactive-resin component (A) containing the reactive resin or of other compositions containing the reactive resin but also for adjustment of the resin reactivity.

The inhibitors that are commonly used for free-radical-polymerizable compounds, as are known to the person skilled in the art, are suitable for this purpose. Preferably, these further inhibitors are selected from among phenolic compounds and non-phenolic compounds and/or phenothiazines.

Phenols, such as 2-methoxyphenol, 4-methoxyphenol, 2,6-di-tert-butyl-4-methylphenol, 2,4-di-tert-butylphenol, 2,6-di-tert-butylphenol, 2,4,6-trimethylphenol, 2,4,6-tris(dimethylaminomethyl)phenol, 4,4′-thio-bis(3-methyl-6-tert-butylphenol), 4,4′-isopropylidenediphenol, 6,6′-di-tert-butyl-4,4′-bis(2,6-di-tert-butylphenol), 1,3,5-trimethyl-2,4,6-tris(3,5-di-tert-butyl-4-hydroxybenzyl)benzene, 2,2′-methylene-di-p-cresol, catechols, such as pyrocatechol, and catechol derivatives, such as butyl pyrocatechols, such as 4-tert-butyl pyrocatechol and 4,6-di-tert-butyl pyrocatechol, hydroquinones, such as hydroquinone, 2-methylhydroquinone, 2-tert-butylhydroquinone, 2,5-di-tert-butylhydroquinone, 2,6-di-tert-butylhydroquinone, 2,6-dimethylhydroquinone, 2,3,5-trimethylhydroquinone, benzoquinone, 2,3,5,6-tetrachloro-1,4-benzoquinone, methylbenzoquinone, 2,6-dimethylbenzoquinone, naphthoquinone, or mixtures of two or more thereof, are suitable as phenolic inhibitors. These inhibitors are often ingredients of commercial free-radical curing reactive-resin components.

Phenothiazines, such as phenothiazine and/or derivatives or combinations thereof, or stable organic free radicals, such as galvinoxyl and N-oxyl free radicals, for example, but not of piperidinyl-N-oxyl or tetrahydropyrrole-N-oxyl type, such as aluminum-N-nitrosophenylhydroxylamine, diethylhydroxylamine, oximes, such as acetaldoxime, acetone oxime, methyl ethyl ketoxime, salicyloxime, benzoxime, glyoximes, dimethylglyoxime, acetone-O-(benzyloxycarbonyl)oxime and the like, may be preferably regarded as non-phenolic inhibitors.

Furthermore, pyrimidinol or pyridinol compounds substituted in para position relative to the hydroxyl group may be used as inhibitors, as described in Patent Specification DE 10 2011 077 248 B1.

Preferably, the further inhibitors are selected from the group of catechols, catechol derivatives, phenothiazines, tert-butylcatechol, Tempol or a mixture of two or more thereof. Particularly preferably, the further inhibitors are selected from the group comprising catechols and phenothiazines. The further inhibitors used in the examples are quite particularly preferred, preferably approximately in the quantities specified in the examples.

Depending on the desired properties of the reactive resin, the further inhibitors may be used either alone or as a combination of two or more thereof.

The inhibitor or the inhibitor mixture is added in the proportions common in the art, preferably in a proportion of approximately 0.0005 to approximately 2 wt % (relative to the reactive resin ultimately produced therewith), more preferably of approximately 0.01 to approximately 1 wt % (relative to the reactive resin), even more preferably from approximately 0.05 to approximately 1 wt % (relative to the reactive resin), even much more preferably from approximately 0.2 to approximately 0.5 wt % (relative to the reactive resin).

The compounds of general formula (I), especially for use in reactive resins and reactive-resin components for chemical fastening and structural adhesive bonding, are generally cured by peroxides as curing agents. The peroxides are preferably initiated by an accelerator, so that polymerization takes place even at low application temperatures. The accelerator is already added to the reactive resin.

Suitable accelerators known to the person skilled in the art are, for example, amines, preferably tertiary amines and/or metal salts.

Suitable amines are selected from among the following compounds: dimethylamine, trimethylamine, ethylamine, diethylamine, triethylamine, n-propylamine, di-n-propylamine, tri-n-propylamine, isopropylamine, diisopropylamine, triisopropylamine, n-butylamine, isobutylamine, tert-butylamine, di-n-butylamine, diisobutylamine, tri-isobutylamine, pentylamine, isopentylamine, diisopentylamine, hexylamine, octylamine, dodecylamine, laurylamine, stearylamine, aminoethanol, diethanolamine, triethanolamine, aminohexanol, ethoxyaminoethane, dimethyl-(2-chloroethyl)amine, 2-ethylhexylamine, bis-(2-chloroethyl)amine, 2-ethylhexylamine, bis-(2-ethylhexyl)amine, N-methylstearylamine, dialkylamines, ethylenediamine, N,N′-dimethylethylenediamine, tetramethylethylenediamine, diethylenetriamine, permethyldiethylenetriamine, triethylenetetramine, tetraethylenepentamine, 1,2-diaminopropane, di-propylenetriamine, tripropylenetetramine, 1,4-diaminobutane, 1,6-diaminohexane, 4-amino-1-diethylaminopentane, 2,5-diamino-2,5-dimethylhexane, trimethylhexamethylenediamine, N, N-dimethylaminoethanol, 2-(2-diethylaminoethoxy)ethanol, bis-(2-hydroxyethyl)-oleylamine, tris-[2-(2-hydroxy-ethoxy)-ethyl]amine, 3-amino-1-propanol, methyl-(3-aminopropyl) ether, ethyl-(3-aminopropyl) ether, 1,4-butanediol-bis(3-aminopropyl ether), 3-dimethylamino-1-propanol, 1-amino-2-propanol, 1-diethylamino-2-propanol, diisopropanolamine, methyl-bis-(2-hydroxypropyl)amine, tris-(2-hydroxypropyl)amine, 4-amino-2-butanol, 2-amino-2-methylpropanol, 2-amino-2-methyl-propanediol, 2-amino-2-hydroxymethylpropanediol, 5-aiethylamino-2-pentanone, 3-methylamino-propionic acid nitrile, 6-aminohexanoic acid, 11-aminoundecanoic acid, 6-aminohexanoic acid ethyl ester, 11-aminohexanoic acid isopropyl ester, cyclohexylamine, N-methylcyclohexylamine, N, N-dimethylcyclohexylamine, dicyclohexylamine, N-ethylcyclohexylamine, N-(2-hydroxyethyl)-cyclohexylamine, N, N-bis-(2-hydroxyethyl)-cyclohexylamine, N-(3-aminopropyl)-cyclohexylamine, aminomethylcyclohexane, hexahydrotoluidine, hexahydrobenzylamine, aniline, N-methylaniline, N,N-dimethylaniline, N,N-diethylaniline, N,N-dipropylaniline, iso-butylaniline, toluidine, diphenylamine, hydroxyethylaniline, bis-(hydroxyethyl)aniline, chloroaniline, aminophenols, aminobenzoic acids and their esters, benzylamine, dibenzylamine, tribenzylamine, methyldibenzylamine, a-phenylethylamine, xylidine, diisopropylaniline, dodecylaniline, aminonaphthalene, N-methylaminonaphthalene, N,N-dimethylaminonaphthalene, N,N-dibenzylnaphthalene, diaminocyclohexane, 4,4′-diamino-dicyclohexylmethane, diamino-dimethyl-dicyclohexylmethane, phenylenediamine, xylylenediamine, diaminobiphenyl, naphthalenediamines, toluidines, benzidines, 2,2-bis-(aminophenyl)-propane, aminoanisoles, amino-thiophenols, aminodiphenyl ethers, aminocresols, morpholine, N-methylmorpholine, N-phenylmorpholine, hydroxyethylmorpholine, N-methylpyrrolidine, pyrrolidine, piperidine, hydroxyethylpiperidine, pyrroles, pyridines, quinolines, indoles, indolenines, carbazoles, pyrazoles, imidazoles, thiazoles, pyrimidines, quinoxalines, aminomorpholine, dimorpholine ethane, [2,2,2]-diazabicyclooctane and N,N-dimethyl-p-toluidine.

According to the invention, di-iso-propanol-p-toluidine or N,N-bis(2-hydroxyethyl)-m-toluidine is used as accelerator.

Preferred amines are aniline derivatives and N,N-bisalkylarylamines, such as N,N-dimethylaniline, N,N-diethylaniline, N,N-dimethyl-p-toluidine, N,N-bis(hydroxyalkyl)arylamines, N,N-bis(2-hydroxyethyl)anilines, N,N-bis(2-hydroxyethyl)toluidine, N,N-bis(2-hydroxypropyl)aniline, N,N-bis(2-hydroxypropyl)toluidine, N, N-bis(3-methacryloyl-2-hydroxypropyl)-p-toluidine, N, N-dibutoxyhydroxypropyl-p-toluidine and 4,4′-bis(dimethylamino)diphenylmethane. Di-iso-propanol-p-toluidine is particularly preferred.

Polymeric amines, such as those obtained by polycondensation of N,N-bis(hydroxyalkyl)aniline with dicarboxylic acids or by polyaddition of ethylene oxide or other epoxides and these amines, are likewise suitable as accelerators.

Suitable metal salts are, for example, cobalt octoate or cobalt naphthenoate as well as vanadium, potassium, calcium, copper, manganese or zirconium carboxylates. Further suitable metal salts are the tin catalysts described hereinabove.

If an accelerator is used, it is introduced in a proportion of 0.01 to 10 wt %, preferably 0.2 to 5 wt % relative to the reactive resin.

The reactive resin may also contain a reactive diluent, if this is necessary. For this purpose, an excess of hydroxy-functionalized (meth)acrylate optionally used during production of the backbone resin may function as the reactive diluent. In addition, if the hydroxyfunctionalized (meth)acrylate is used in approximately equimolar proportions with the isocyanate group, or additionally, if an excess of hydroxyfunctionalized (meth)acrylate is used, further reactive diluents, which are structurally different from the hydroxyfunctionalized (meth)acrylate, may be added to the reaction mixture.

Suitable reactive diluents are low-viscosity, free-radical-co-polymerizable compounds, preferably compounds exempt from labeling, which are added if necessary in order to adapt the viscosity among other properties of the urethane methacrylate or of the precursors during the production thereof.

Suitable reactive diluents are described in the Applications EP 1 935 860 A1 and DE 195 31 649 A1. Preferably, the reactive resin (the resin mixture) contains, as reactive diluent, a (meth)acrylic acid ester, wherein aliphatic or aromatic C₅-C₁₅ (meth)acrylates are selected particularly preferably. Suitable examples include: 2-hydroxypropyl (meth)acrylate, 3-hydroxypropyl (meth)acrylate, 1,2-ethanediol di-(meth)acrylate, 1,3-propanediol dimethacrylate, 1,3-butanediol di(meth)acrylate, 1,4-butanediol di(meth)acrylate, trimethylolpropane tri(meth)acrylate, phenylethyl (meth)acrylate, tetrahydrofurfuryl (meth)acrylate, ethyl triglycol (meth)acrylate, N,N-dimethylaminoethyl (meth)acrylate, N,N-dimethylaminomethyl (meth)acrylate, N, N-diethylaminoethyl (meth)acrylate, acetoacetoxyethyl (meth)acrylate, isobornyl (meth)acrylate, 2-ethylhexyl (meth)acrylate, tert-butylcyclohexyl (meth)acrylate, benzyl (meth)acrylate, methyl (meth)acrylate, n-butyl (meth)acrylate, iso-butyl (meth)acrylate, 3-trimethoxysilylpropyl (meth)acrylate, isodecyl (meth)acrylate, diethylene glycol di(meth)acrylate, triethylene glycol di(meth)acrylate, methoxypolyethylene glycol mono(meth)acrylate, trimethylcyclohexyl (meth)acrylate, 2-hydroxyethyl (meth)acrylate, dicyclopentenyloxyethyl (meth)acrylate and/or tricyclopentadienyl di(meth)acrylate, bisphenol A (meth)acrylate, novolac epoxy di(meth)acrylate, di-[(meth)acryloyl-maleoyl]-tricyclo-5.2.1.0.2.6-decane, 3-(meth)acryloyl-oxymethyl-tricylo-5.2.1.0.2.6-decane, 3-(meth)cyclo-pentadienyl (meth)acrylate and decalyl-2-(meth)acrylate; PEG di(meth)acrylate, such as PEG200 di(meth)acrylate, tetraethylene glycol di(meth)acrylate, solketal (meth)acrylate, cyclohexyl (meth)acrylate, phenoxyethyl di(meth)acrylate, 2-phenoxyethyl (meth)acrylate, hexanediol-1,6-di(meth)acrylate, 1,2-butanediol di(meth)acrylate, methoxyethyl (meth)acrylate, butyldiglycol (meth)acrylate, tert-butyl (meth)acrylate and norbornyl (meth)acrylate. Methacrylates are preferred over acrylates.

2- and 3-Hydroxypropyl methacrylate, 1,2-ethanediol dimethacrylate, 1,4-butanediol dimethacrylate, 1,3-butanediol dimethacrylate, glycerol dimethacrylate, trimethylolpropane trimethacrylate, acetoacetoxyethyl methacrylate, isobornyl methacrylate, bisphenol A dimethacrylate, ethoxylated bisphenol A methacrylates such as E2BADMA or E3BADMA, trimethylcyclohexyl methacrylate, 2-hydroxyethyl methacrylate, PEG200 dimethacrylate and norbornyl methacrylate are particularly preferred and a mixture of 2- and 3-hydroxypropyl methacrylate and 1,4-butanediol dimethacrylate or a mixture of these three methacrylates is quite particularly preferred.

The most preferred is a mixture of 2- and 3-hydroxypropyl methacrylate. In principle, other common free-radical-polymerizable compounds may also be used as reactive diluents, alone or in a mixture with the (meth)acrylic acid esters, e.g. methacrylic acid, styrene, α-methylstyrene, alkylated styrenes, such as tert-butylstyrene, divinylbenzene and vinyl as well as allyl compounds, wherein the representatives thereof that are exempt from labeling are preferred. Examples of such vinyl or allyl compounds are hydroxybutyl vinyl ether, ethylene glycol divinyl ether, 1,4-butanediol divinyl ether, trimethylolpropane divinyl ether, trimethylolpropane trivinyl ether, mono-, di-, tri-, tetra- and polyalkylene glycol vinyl ethers, mono-, di-, tri-, tetra- and polyalkylene glycol allyl ethers, adipic acid divinyl ester, trimethylolpropane diallyl ether and trimethylolpropane triallyl ether.

The reactive diluent or diluents is or are added in a proportion up to 65 wt %, preferably up to 60 wt %, further preferably up to 55 wt %, particularly preferably in proportions below 50 wt %, relative to the reactive resin.

An exemplary reactive resin comprises a compound of general formula (I)

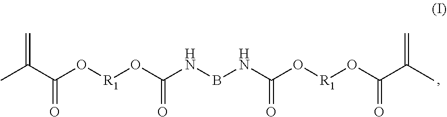

in which B is an aromatic hydrocarbon group and each R₁, independently of one another, is a branched or linear aliphatic C₁-C₁₅ alkylene group, as the backbone resin, a stable nitroxyl free radical as the inhibitor, a substituted toluidine as the accelerator and optionally a reactive diluent.

A preferred reactive resin comprises (a) a compound of formula (II) or (III)

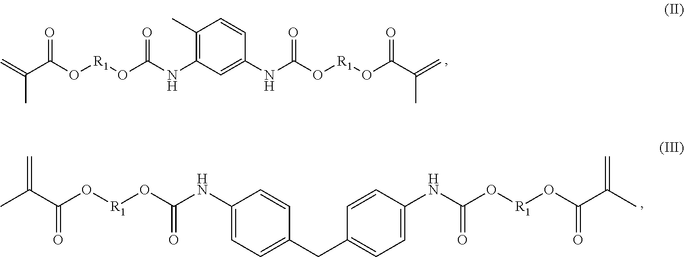

in which each R₁, independently of one another, is a branched or linear aliphatic C₁-C₁₅ alkylene group, as the backbone resin, a stable nitroxyl free radical as the inhibitor, a substituted toluidine as the accelerator and optionally a reactive diluent.

A further preferred reactive resin comprises a compound of formula (IV) or (V)

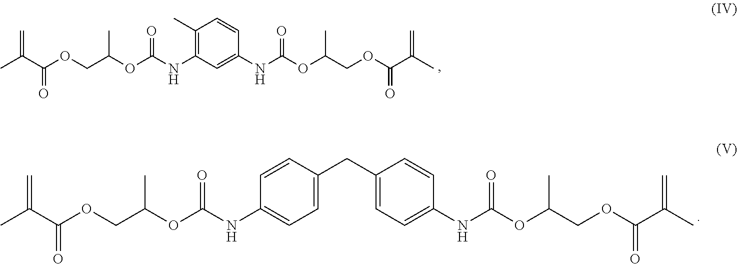

as the backbone resin, a stable nitroxyl free radical as the inhibitor, a substituted toluidine as the accelerator and a reactive diluent.

A particularly preferred reactive resin comprises a compound of formula (IV) or (V) as the backbone resin, 4-hydroxy-2,2,6,6-tetramethyl-piperidinyl-1-oxyl (TEMPOL) as the inhibitor, di-iso-propanol-p-toluidine as the accelerator and a mixture of hydroxypropyl methacrylate and 1,4-butanediol dimethacrylate (BDDMA) as the reactive diluent.

By virtue of the low-viscosity backbone resin, an inventive reactive resin has particularly low dynamic viscosity, and so it is possible to produce, for a reactive-resin system, a reactive-resin component, which exhibits substantially lower extrusion forces at application temperatures below 10° C., preferably at 0° C., than do conventional systems, without the high proportions of reactive diluents needed heretofore for the purpose.

A further subject matter of the invention is a reactive-resin component that contains the reactive resin. The reactive-resin component may contain inorganic aggregates, such as fillers and/or additives, in addition to the inventive reactive resin. It should be pointed out that some substances, both as fillers and optionally in modified form, may also be used as additive. For example, fumed silica functions more as a filler in its polar, non-post-treated form and more as an additive in its apolar, post-treated form. In cases in which exactly the same substance can be used as filler or additive, the total quantity thereof should not exceed the upper limit stipulated herein for fillers.

For production of a reactive-resin component for construction purposes, especially chemical fastening, common fillers and/or additives may be added to the inventive reactive resin. These fillers are typically inorganic fillers and additives, such as described hereinafter by way of example.

The proportion of the reactive resin in the reactive-resin component preferably ranges from approximately 10 to approximately 70 wt %, more preferably from approximately 30 to approximately 50 wt %, relative to the reactive-resin component. Accordingly, the proportion of fillers preferably ranges from approximately 90 to approximately 30 wt %, more preferably from approximately 70 to approximately 50 wt %, relative to the reactive-resin component.

Common fillers, preferably mineral or mineral-like fillers, such as quartz, glass, sand, quartz sand, quartz flour, porcelain, corundum, ceramic, talc, silica (e.g. fumed silica, especially polar non-post-treated fumed silica), silicates, aluminum oxides (e.g. alumina), clay, titanium dioxide, chalk, heavy spar, feldspar, basalt, aluminum hydroxide, granite or sandstone, polymeric fillers such as thermosetting plastics, hydraulically curable fillers, such as gypsum, burnt lime or cement (e.g. aluminate cement (often also referred to as aluminous cement) or Portland cement), metals, such as aluminum, carbon black, further wood, mineral or organic fibers or the like, or mixtures of two or more thereof, are used as fillers. The fillers may exist in any desired forms, for example as powder or flour or as shaped bodies, e.g. in the form of cylinders, rings, balls, platelets, rods, shells or crystals, or further in fiber form (fibrillar fillers), and the corresponding basic particles preferably have a maximum diameter of approximately 10 mm and a minimum diameter of approximately 1 nm. This means that the diameter is approximately 10 mm or any value smaller than approximately 10 mm, but larger than approximately 1 nm. Preferably the maximum diameter is a diameter of approximately 5 mm, more preferably of approximately 3 mm, even more preferably of approximately 0.7 mm. A maximum diameter of approximately 0.5 mm is quite particularly preferred. The more preferred minimum diameter is approximately 10 nm, even more preferably approximately 50 nm, quite particularly preferably approximately 100 nm. Diameter ranges obtained by combination of this maximum diameter and minimum diameter are particularly preferred. However, the globular inert substances (spherical shape), which have a distinctly more reinforcing effect, are preferred. Core-shell particles, preferably with spherical shape, may also be used as fillers.

Preferred fillers are selected from the group consisting of cement, silica, quartz, quartz sand, quartz flour and mixtures of two or more thereof. Fillers selected from the group consisting of cement, fumed silica, especially untreated, polar fumed silica, quartz sand, quartz flour and mixtures of two or more thereof are particularly preferred for the reactive-resin component (A). A mixture of cement (especially aluminate cement (often also referred to as aluminous cement) or Portland cement), fumed silica and quartz sand is quite particularly preferred for the reactive-resin component (A). For the hardener component (B), fumed silica is preferred as the sole filler or as one of several fillers; particularly preferably, not only fumed silica but also one or more further fillers are present.

Common additives, i.e. thixotropic agents, such as, optionally, organically or inorganically post-treated fumed silica (except if it is already being used as filler), especially apolarly post-treated fumed silica, bentonites, alkyl and methyl celluloses, castor oil derivatives or the like, plasticizers, such as phthalic acid or sebacic acid ester, further stabilizers in addition to the stabilizers and inhibitors used according to the invention, antistatic agents, thickening agents, flexibilizers, rheology additives, wetting agents, coloring additives, such as dyes or especially pigments, for example for different coloration of the components to permit better control of intermixing thereof, or the like, or mixtures of two or more thereof, are used as additives. Non-reactive diluents (solvents) may also be included, preferably in a proportion of up to 30 wt % relative to the total quantity of the reactive-resin component, such as lower alkyl ketones, e.g. acetone, di-lower-alkyl lower alkanoylamides, such as dimethylacetamide, lower alkylbenzenes, such as xylenes or toluene, phthalic acid esters or paraffins, water or glycols. Furthermore, metal scavengers in the form of surface-modified fumed silicas may be contained in the reactive-resin component. Preferably, at least one thixotropic agent is present as additive, particularly preferably an organically or inorganically post-treated fumed silica, quite particularly preferably an apolarly post-treated fumed silica.

In this respect, reference is made to the Applications WO 02/079341 and WO 02/079293 as well as WO 2011/128061 A1.

The proportion of additives in the reactive-resin component may range up to approximately 5 wt %, relative to the reactive-resin component.

The reactive resins produced according to the invention can be used in many areas, in which unsaturated polyester resins, vinyl ester resins or vinyl ester urethane resins are otherwise commonly used. They are commonly used as resin ingredient in the reactive-resin component of a reactive-resin system, such as a multi-component system, typically a two-component system comprising a reactive-resin component (A) and a hardener component (B). This multi-component system can exist in the form of a cartridge system, a canister system or a film-bag system. During use of the system as intended, the components are extruded from the cartridges, canisters or film bags either by application or mechanical forces or by gas pressure, mixed with one another, preferably using a static mixer, through which the ingredients are conveyed, and applied.

Subject matter of the present invention is therefore also a reactive-resin system having a reactive-resin component (A) and a hardener component (B) as just described, that contains an initiator for the urethane methacrylate compound.

The initiator is customarily a peroxide. All peroxides known to the person skilled in the art that are used for curing of unsaturated polyester resins and vinyl ester resins may be employed. Such peroxides comprise organic and inorganic peroxides that are either liquid or solid, wherein hydrogen peroxide may also be used. Examples of suitable peroxides are peroxycarbonates (of the formula —OC(O)O—), peroxy esters (of the formula —C(O)OO—), diacyl peroxides (of the formula —C(O)OOC(O)—), dialkyl peroxides (of the formula —OO—) and the like. These may be present as oligomers or polymers.

Preferably, the peroxides are selected from the group of organic peroxides. Suitable organic peroxides are: tertiary alkyl hydroperoxides, such as tert-butyl hydroperoxide, and other hydroperoxides, such as cumene hydroperoxide, peroxy esters or peracids, such as tert-butyl peresters, benzoyl peroxide, peracetates and perbenzoates, lauryl peroxide, including (di)peroxy esters, perethers, such as peroxy diethyl ether, perketones, such as methyl ethyl ketone peroxide. The organic peroxides used as hardeners are often tertiary peresters or tertiary hydroperoxides, i.e. peroxide compounds with tertiary carbon atoms, which are bound directly to an —O—O-acyl- or —OOH— group. However, mixtures of these peroxides with other peroxides may also be used according to the invention. The peroxides may also be mixed peroxides, i.e. peroxides that have two different peroxide-carrying units in one molecule. Preferably, (di-benzoyl) peroxide (BPO) is used for curing.

The reactive-resin system may be present in the form of a two-component or multi-component system, in which the respective components exist spatially separated from one another, so that a reaction (curing) of the components take place only after they have been mixed.

A two-component reactive-resin system preferably comprises the A component and the B component separated, to ensure inhibition of reaction, into different containers, for example of a multi-chamber apparatus, such as a multi-chamber cartridge and/or canister, from which containers the two components are extruded by application of mechanical pressing forces or by application of a gas pressure and then mixed. A further possibility consists in packaging the two-component reactive-resin system as two-component capsules, which are introduced into the drilled hole and destroyed by percussively turning the fastening element to set it while simultaneously intermixing the two components of the fastening caulk. Preferably, a cartridge system or an injection system is used herein, in which the two components are extruded from the separated containers and passed through a static mixer, in which they are mixed homogeneously and then discharged via a nozzle, preferably directly into the drilled hole.

In a preferred embodiment of the inventive reactive-resin system, the reactive-resin system is a two-component system, and the reactive-resin component (A) contains not only the backbone resin but additionally also a hydraulically binding or polycondensable inorganic compound, especially cement, and the hardener component (B) contains not only the initiator for polymerization of the backbone resin but also water. Such hybrid mortar systems are described in detail in DE 4231161 A1. Therein, component (A) preferably contains cement as the hydraulically binding or polycondensable inorganic compound, for example Portland cement or aluminous cement, wherein cements free of transition metal oxides or low in transition metals are particularly preferred. Gypsum as such or mixed with the cement may also be used as the hydraulically binding inorganic compound. Component (A) may also comprise, as the polycondensable inorganic compound, silicatic polycondensable compounds, especially substances containing soluble, dissolved and/or amorphous silicon dioxide, such as, for example, polar, non-post-treated fumed silica.

The volume ratio of component A to component B in a two-component system is preferably 3:1, 5:1 or 7:1. A volume ratio of 3:1 or 5:1 is particularly preferred.

In a preferred embodiment, the reactive-resin component (A) therefore contains the following:
at least one urethane (meth)acrylate as defined hereinabove, preferably a compound of formula (II) or (III);
at least one inhibitor of piperidinyl-N-oxyl or tetrahydropyrrole-N-oxyl type as defined hereinabove, preferably TEMPOL;
at least one accelerator defined as hereinabove, preferably a toluidine derivative, particularly preferably di-iso-propanol-p-toluidine;
at least one hydraulically binding or polycondensable inorganic compound, preferably cement; and
at least one thixotropic agent, preferably fumed silica,
   and the hardener component (B) contains:
at least one initiator for initiation of polymerization of the urethane (meth)acrylate, preferably benzoyl peroxide (BPO) or tert-butyl peroxybenzoate; and
water.

In a more preferred embodiment, the reactive-resin component (A) contains:
at least one urethane (meth)acrylate as defined hereinabove, preferably a compound of formula (II) or (III);
at least one inhibitor of piperidinyl-N-oxyl or tetrahydropyrrole-N-oxyl type as defined hereinabove, preferably TEMPOL;
at least one accelerator, preferably a toluidine derivative, particularly preferably di-iso-propanol-p-toluidine;
at least one hydraulically binding or polycondensable inorganic compound, preferably cement; and
at least one thixotropic agent, preferably fumed silica,
   and the hardener component (B) contains:
at least one initiator for initiation of polymerization of the urethane (meth)acrylate, preferably benzoyl peroxide (BPO) or tert-butyl peroxybenzoate;
at least one filler, preferably quartz sand or quartz flour; and
water.

In an even more preferred embodiment, the reactive-resin component (A) contains:
at least one urethane (meth)acrylate as defined hereinabove, preferably a compound of formula (II) or (III);
at least one inhibitor of piperidinyl-N-oxyl or tetrahydropyrrole-N-oxyl type as defined hereinabove, preferably TEMPOL;
at least one accelerator, preferably a toluidine derivative, particularly preferably di-iso-propanol-p-toluidine;
at least one further inhibitor, which is selected from the group consisting of catechols and phenothiazines;
at least one hydraulically binding or polycondensable inorganic compound, preferably cement; and
at least one thixotropic agent, preferably fumed silica,
   and the hardener component (B) contains:
at least one initiator for initiation of polymerization of the urethane (meth)acrylate, preferably benzoyl peroxide (BPO) or tert-butyl peroxybenzoate;
at least one filler, preferably quartz sand or quartz flour;
at least one thixotropic agent, preferably fumed silica; and
water.

In an even more preferred embodiment, the reactive-resin component (A) contains:
at least one urethane (meth)acrylate as defined hereinabove, preferably a compound of formula (II) or (III);
at least one inhibitor of piperidinyl-N-oxyl or tetrahydropyrrole-N-oxyl type as defined hereinabove, preferably TEMPOL;
at least one accelerator, preferably a toluidine derivative, particularly preferably di-iso-propanol-p-toluidine;
at least one further inhibitor, which is selected from the group consisting of catechols and phenothiazines;
at least one hydraulically binding or polycondensable inorganic compound, preferably cement;
at least one thixotropic agent, preferably fumed silica; and
at least one further filler, preferably quartz sand;
   and the hardener component (B) contains:
benzoyl peroxide (BPO) or tert-butyl peroxybenzoate as the initiator for initiation of polymerization of the urethane (meth)acrylate;
at least one filler, preferably quartz sand or quartz flour;
at least one thixotropic agent, preferably fumed silica; and
water.

In an even more preferred embodiment, the reactive-resin component (A) contains:
at least one urethane (meth)acrylate as defined hereinabove, preferably a compound of formula (IV) or (V);
TEMPOL;
di-iso-propanol-p-toluidine;
at least one further inhibitor, which is selected from the group consisting of catechols and phenothiazines;
cement;
fumed silica; and
quartz sand,
   and the hardener component (B) contains:
at least one initiator for initiation of polymerization of the urethane (meth)acrylate;
fumed silica;
quartz sand or quartz flour and
water.

In each of these embodiments, the reactive-resin component (A) additionally also contains, in a preferred embodiment, at least one reactive diluent. Preferably, this reactive diluent is a monomer or a mixture of several monomers of the backbone resin.

In each of these embodiments, the reactive-resin components (A) and the hardener components (B) can be combined with one another in any desired manner.

Such a reactive-resin system is used above all in the building sector (construction purposes), for example for creation and maintenance or repair of building parts and building structures, for example of concrete, as a polymer concrete, as a plastic-based coating caulk or as a cold-curing road marking, for reinforcement of building parts and building structures, for example walls, ceilings or floors, the fastening of building parts, such as panels or blocks, for example of stone, glass or plastic, on building parts or building structures, for example by adhesive bonding (constructional adhesive bonding). It is particularly suitable for chemical fastening. It is quite particularly suitable for chemical fastening (by substance-to-substance and/or interlocking joining) of anchoring means, such as anchor rods, bolts, rebars, screws or the like in recesses, such as drilled holes, especially in holes drilled in various substrates, especially mineral substrates, such as those on the basis of concrete, cellular concrete, brickwork, lime sandstone, sandstone, natural rock, glass and the like, and metallic substrates, such as those of steel. In one embodiment, the substrate of the drilled hole is concrete and the anchoring means consists of steel or iron. In a further embodiment, the substrate of the drilled hole is steel and the anchoring means consists of steel or iron. For this purpose, the components are injected into the drilled hole, after which the devices to be fastened, such as threaded anchor rods and the like, are introduced into the drilled hole charged with the curing reactive resin and are appropriately adjusted.

The invention will be further explained on the basis of the following examples.

### EXAMPLES

First of all, reactive resins, reactive-resin components and two-component reactive-resin systems respectively containing the inventive compound (IV) as backbone resin were produced. The dynamic viscosity of the reactive resins and of the reactive-resin components were determined, as were the forces for extruding the two-component reactive-resin systems and the bond strengths of the cured fastening caulks.

### Inventive Compound (IV)

### A1. Production of Reactive-Resin Master Batch A1 Containing Compound (IV)

1542 g Hydroxypropyl methacrylate was first introduced into a 2-liter glass laboratory reactor with internal thermometer and stirrer shaft then 0.24 g phenothiazine (D Prills; Allessa Chemie), 0.60 g 4-hydroxy-2,2,6,6-tetramethyl-piperidinyl-1-oxyl (TEMPOL; Evonik Degussa GmbH) and 0.40 g dioctyltin dilaurate (TIB KAT® 216; TIB Chemicals) were added. The batch was heated to 80° C. Then 500 g toluene-2,4-diisocyanate (TDI; TCI Deutschland GmbH) was added with stirring at 200 rpm within 45 minutes. Thereafter stirring was continued for a further 180 minutes at 80° C.

Hereby reactive-resin master batch A1 containing 65 wt % of compound (IV) as backbone resin and 35 wt % hydroxypropyl methacrylate, relative to the total weight of the reactive-resin master batch, was obtained.

Compound (IV) has the following structure:

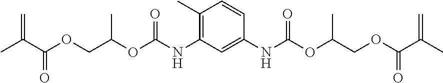 [SMILES: C=C(C)C(=O)OCC(C)OC(=O)Nc1ccc(C)c(NC(=O)OC(C)COC(=O)C(=C)C)c1]

A reactive resin (A2.1) containing 33 wt % and a reactive resin (A2.2) containing 41 wt % of compound (IV) as the backbone resin was produced from reactive-resin master batch A1.

### A2.1 Production of Reactive Resin A2.1 Containing 33 wt % of Compound (IV)

301 g Reactive-resin master batch A1 was mixed with 90 g hydroxypropyl methacrylate and 196 g 1,4-butanediol dimethacrylate (BDDMA; Evonik AG). 2.75 g 4-Hydroxy-2,2,6,6-tetramethyl-piperidinyl-1-oxyl (TEMPOL; Evonik Degussa GmbH) and 10.5 g di-iso-propanol-p-toluidine (BASF SE) were added to this mixture.

Hereby reactive-resin A2.1 containing a proportion of 33 wt % of compound (IV) as backbone resin was obtained.

### A2.2 Production of Reactive Resin A2.2 Containing 41 wt % of Compound (IV)

376 g Reactive-resin master batch A1 was mixed with 39 g hydroxypropyl methacrylate and 171 g 1,4-butanediol dimethacrylate (BDDMA; Evonik AG). 2.75 g 4-Hydroxy-2,2,6,6-tetramethyl-piperidinyl-1-oxyl (TEMPOL; Evonik Degussa GmbH) and 10.5 g di-iso-propanol-p-toluidine (BASF SE) were added to this mixture.

Hereby reactive-resin A2.2 containing a proportion of 41 wt % of compound (IV) as backbone resin was obtained.

### A3. Production of Reactive-Resin Components A3. And A3.2

354 g Reactive resin A2.1 or A2.2 was mixed with 185 g Secar® 80 (Kemeos Inc.), 27 g Cab-O-Sil® TS-720 (Cabot Corporation) and 335 g quartz sand F32 (Quarzwerke GmbH), using a PC Labor System Dissolver of LDV 0.3-1 type for 8 minutes at 3500 rpm under vacuum (pressure<100 mbar) with a 55 mm dissolver disk and an edge scraper.

Hereby reactive-resin components A3.1 and A3.2 were obtained.

From these, reactive-resin systems were produced as two-component systems.

### A4. Production of Two Component Reactive-Resin Systems A4.1 and A4.2

For production of the two-component reactive-resin systems A4.1 and A4.2, the reactive-resin components A3.1 and A3.2 (component (A)) and respectively the hardener component (component (B)) of the commercially available product HIT-HY 110 (Hilti Aktiengesellschaft; batch number: 1610264) were filled into plastic canisters (Ritter GmbH; volume ratio A:B=3:1) with inside diameters of 47 mm (component (A)) and respectively 28 mm (component (B)).

Hereby the two-component reactive-resin systems A4.1 (containing a proportion of 33 wt % of compound (IV) in the reactive resin) and A4.2 (containing a proportion of 41 wt % of compound (IV) in the reactive resin) were obtained.

In order to introduce a higher proportion of compound (IV) into a reactive resin, a further reactive-resin master batch (B1) with a high proportion of 80 wt % of compound (IV) was produced.

### B1. Production of Reactive-Resin Master Batch B1 Containing Compound (IV)

1396 g Hydroxypropyl methacrylate was first introduced into a 2-liter glass laboratory reactor with internal thermometer and stirrer shaft then 0.29 g phenothiazine (D Prills; Allessa Chemie), 0.70 g 4-hydroxy-2,2,6,6-tetramethyl-piperidinyl-1-oxyl (TEMPOL; Evonik Degussa GmbH) and 0.49 g dioctyltin dilaurate (TIB KAT 216; TIB Chemicals) were added. The batch was heated to 80° C. Then 602 g toluene-2,4-diisocyanate (TCI Deutschland GmbH) was added with stirring at 200 rpm within 45 minutes. Thereafter stirring was continued for a further 180 minutes at 80° C.

Hereby reactive-resin master batch B1 containing 80 wt % of compound (IV) as backbone resin and 20 wt % hydroxypropyl methacrylate, relative to the total weight of the reactive-resin master batch, was obtained.

Reactive resins containing different proportions of compound (IV) as the backbone resin were likewise produced from reactive-resin master batch B1.

### B2.1 Production of Reactive Resin B2.1 Containing 37 wt % of Compound (IV)

186 g Reactive-resin master batch from B1 was mixed with 43 g hydroxypropyl methacrylate and 160 g 1,4-butanediol dimethacrylate (BDDMA; Evonik AG). 1.08 g Pyrocatechol (manufacturer Solvay Catechol Flakes) and 0.36 g 4-tert-butylpyrocatechol and 9.2 g di-iso-propanol-p-toluidine (BASF SE) were added to this mixture.

Hereby reactive resin B2.1 containing a proportion of 37 wt % of compound (IV) as backbone resin was obtained.

### B2.2 Production of Reactive Resin B2.2 Containing 40 wt % of Compound (IV)

200 g Reactive-resin master batch B1 was mixed with 37 g hydroxypropyl methacrylate and 153 g 1,4-butanediol dimethacrylate (BDDMA; Evonik AG). 1.08 g Pyrocatechol (manufacturer Solvay Catechol Flakes) and 0.36 g 4-tert-butylpyrocatechol and 9.2 g di-iso-propanol-p-toluidine (manufacturer BASF SE) were added to this mixture.

Hereby reactive resin B2.2 containing a proportion of 40 wt % of compound (IV) as backbone resin was obtained.

### B2.3 Production of Reactive Resin B2.3 Containing 45 wt % of Compound (IV)

225 g Reactive-resin master batch B1 was mixed with 26 g hydroxypropyl methacrylate and 140 g 1,4-butanediol dimethacrylate (BDDMA; Evonik AG). 1.08 g Pyrocatechol (manufacturer Solvay Catechol Flakes) and 0.36 g 4-tert-butylpyrocatechol and 9.2 g di-iso-propanol-p-toluidine (BASF SE) were added to this mixture.

Hereby reactive resin B2.3 containing a proportion of 45 wt % of compound (IV) as backbone resin was obtained.

### B2.4 Production of Reactive Resin B2.4 Containing 50 wt % of Compound (IV)

250 g Reactive-resin master batch B1 was mixed with 13 g hydroxypropyl methacrylate and 127 g 1,4-butanediol dimethacrylate (BDDMA; Evonik AG). 1.08 g Pyrocatechol (manufacturer Solvay Catechol Flakes) and 0.36 g 4-tert-butylpyrocatechol and 9.2 g di-iso-propanol-p-toluidine (BASF SE) were added to this mixture.

Hereby reactive resin B2.4 containing a proportion of 50 wt % of compound (IV) as backbone resin was obtained.

### B3. Production of Reactive-Resin Components B3.1. B3.2. B3.3 and B3.4

Respectively 311 g reactive resin B2.1, B2.2, B2.3 and B2.4 were mixed with 167 g Secar® 80 (Kemeos Inc.), 9 g Cab-O-SiP TS-720 (Cabot Corporation), 16 g Aerosil® R812 (Evonik Industries AG) and 398 g quartz sand F32 (Quarzwerke GmbH) in the dissolver under vacuum. Mixing was carried out with a PC Labor System Dissolver of LDV 0.3-1 type, as described under heading A3.

Hereby reactive-resin components B3.1, B3.2, B3.3 and B3.4 containing compound (IV) as backbone resin were obtained.

From these, reactive-resin systems were produced as two-component systems.

### B4. Production of Two-Component Reactive-Resin Systems B4.1 to B4.4

For production of the two-component reactive-resin systems B4.1, B4.2, B4.3 and B4.4, the reactive-resin components B3.1, B3.2, B3.3 and B3.4 (component (A)) and respectively the hardener component (component (B)) of the commercially available product HIT HY-200 (Hilti Aktiengesellschaft; batch number 8104965) were filled into plastic canisters (Ritter GmbH; volume ratio A:B=5:1) with inside diameters of 32.5 mm (component (A)) and respectively 14 mm (component (B)).

Hereby the two-component reactive-resin systems B4.1 (containing a proportion of 37 wt % of compound (IV) in the reactive resin), B4.2 (containing a proportion of 40 wt % of compound (IV) in the reactive resin), B4.3 (containing a proportion of 45 wt % of compound (IV) in the reactive resin) and B4.4 (containing a proportion of 50 wt % of compound (IV) in the reactive resin) were obtained.

### Comparison Examples C and D

For comparison, reactive-resin master batches, reactive resins and reactive-resin components containing comparison compounds 1 and 2 were produced as follows.

### C1. Production of Comparison Reactive-Resin Master Batch C1 Containing Comparison Compound 1

Comparison reactive-resin master batch C1 containing 65 wt % comparison compound 1 as backbone resin and 35 wt % hydroxypropyl methacrylate was produced according to the method in EP 0 713 015 A1, which is included herewith as reference and to the entire disclosure of which reference is made.

The product (comparison compound 1) has an oligomer distribution, wherein the oligomer containing a repeat unit has the following structure:

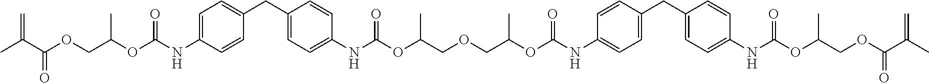

### C2.1 Production of Comparison Reactive Resin C2.1 Containing 33 wt % of Comparison Compound 1

9.2 g 4-Hydroxy-2,2,6,6-tetramethyl-piperidinyl-1-oxyl (TEMPOL; Evonik Degussa GmbH) and 35.0 g di-iso-propanol-p-toluidine (BASF SE) were added to a mixture of 1004 g reactive-resin master batch from C1, 300 g hydroxypropyl methacrylate and 652 g 1,4-butanediol dimethacrylate (BDDMA; Evonik AG).

Hereby comparison reactive-resin C2.1 containing 33 wt % of comparison compound 1 as backbone resin was obtained.

### C2.2 Production of Comparison Reactive Resin 1 Containing 37 wt % of Comparison Compound 1

229 g Reactive-resin master batch C1 was mixed with 160 g 1,4-butanediol dimethacrylate (BDDMA; Evonik AG). 1.08 g Pyrocatechol (manufacturer Solvay, Catechol Flakes) and 0.36 g 4-tert-butylpyrocatechol (tBBK, CFS EUROPE S.p.A. (Borregaard Italia S.p.A.)) and 9.2 g di-iso-propanol-p-toluidine (BASF SE) were added to this mixture.

Hereby comparison reactive-resin C2.2 containing 37 wt % of comparison compound 1 as backbone resin was obtained.

### C2.3 Production of Comparison Reactive Resin C2.3 Containing 41 wt % of Comparison Compound 1

2.8 g 4-Hydroxy-2,2,6,6-tetramethyl-piperidinyl-1-oxyl (TEMPOL; Evonik Degussa GmbH) and 10.5 g di-iso-propanol-p-toluidine (BASF SE) were added to a mixture of 337 g comparison reactive-resin master batch C1, 39 g hydroxypropyl methacrylate and 171 g 1,4-butanediol dimethacrylate.

Hereby comparison reactive-resin C2.3 containing 41 wt % of comparison compound 1 as backbone resin was obtained.

### C3. Production of Comparison Reactive-Resin Components C3.1 to C3.3

Respectively 354 g comparison reactive resin C2.1 and C2.3 were mixed with 185 g Secar® 80 (Kemeos Inc.), 27 g Cab-O-Si TS-720 (Cabot Corporation) and 335 g quartz sand F32 (Quarzwerke GmbH) in the dissolver under vacuum. Mixing was carried out with a PC Labor System Dissolver of LDV 0.3-1 type, as described under heading A3.

Hereby the comparison reactive-resin components C3.1 containing 33 wt % comparison compound 1 in the reactive resin (from C2.1) and C3.2 containing 41 wt % comparison compound 1 in the reactive resin (from C2.3) were obtained.

311 g Comparison reactive resin C2.2 was mixed with 167 g Secar® 80 (Kerneos Inc.), 9 g Cab-O-SiP TS-720 (Cabot Corporation), 16 g Aerosil® R812 (Evonik Industries AG) and 398 g quartz sand F32 (Quarzwerke GmbH) in the dissolver under vacuum. Mixing was carried out with a PC Labor System Dissolver of LDV 0.3-1 type, as described under heading A3.

Hereby the comparison reactive-resin components C3.3 containing 37 wt % comparison compound in the reactive resin (from C2.2) was obtained.

### C4. Production of Comparison Two-Component Reactive-Resin Systems C4.1 to C4.3

For production of the comparison two-component reactive-resin systems C4.1 and C4.2, the reactive-resin components C3.1 and C3.2 (component (A)) and respectively the hardener component (component (B)) of the commercially available product HIT-HY 110 (Hilti Aktiengesellschaft; batch number: 1610264) were filled into plastic canisters (Ritter GmbH; volume ratio A:B=3:1) with inside diameters of 47 mm (component (A)) and respectively 28 mm (component (B)).

Hereby the two-component comparison reactive-resin systems C4.1 containing 33 wt % comparison compound 1 in the reactive resin (from C3.1) and C4.2 containing 41 wt % comparison compound 1 in the reactive resin (from C3.2) were obtained.

For production of the comparison two-component reactive-resin system C4.3, the reactive-resin components C3.3 (component (A)) and respectively the hardener component (component (B)) of the commercially available product HIT-HY 200 (Hilti Aktiengesellschaft; batch number 8104965) were filled into plastic canisters (Ritter GmbH; volume ratio A:B=5:1) with inside diameters of 32.5 mm (component (A)) and respectively 14 mm (component (B)).

Hereby comparison two-component reactive-resin system C4.3 containing 37 wt % of comparison compound 1 in the reactive resin (from C3b) was obtained.

### D1. Production of Comparison Reactive-Resin Master Batch D1 Containing Comparison Compound 2

The comparison reactive-resin master batch D1 containing respectively 65 wt % comparison compound 2 as backbone resin and 35 wt % hydroxypropyl methacrylate, respectively relative to the total weight of the reactive-resin master batch, was produced according to the method in EP 0 713 015 A1, which is included herewith as reference and to the entire disclosure of which reference is made.

Comparison compound 2 has the following structure:

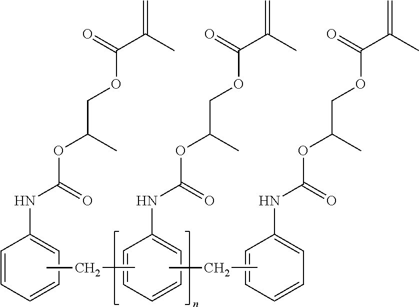

From this, comparison reactive resins containing different proportions of comparison compound 2 were produced.

### D2. Production of Comparison Reactive Resin D2

4.6 g 4-Hydroxy-2,2,6,6-tetramethyl-piperidinyl-1-oxyl (TEMPOL; Evonik Degussa GmbH) and 17.5 g di-iso-propanol-p-toluidine (BASF SE) were added to a mixture of 502 g comparison reactive-resin master batch D1, 150 g hydroxypropyl methacrylate and 326 g 1,4-butanediol dimethacrylate (1,4-BDDMA; Evonik Degussa GmbH).

Hereby comparison reactive resin D2 containing comparison compound 2 as backbone resin was obtained.

### D3. Production of Comparison Reactive-Resin Component D3

354 g Comparison reactive resin D2 was mixed with 185 g Secar® 80 (Kemeos Inc.), 27 g Cab-O-Sil® TS-720 (Cabot Corporation) and 335 g quartz sand F32 (Quarzwerke GmbH) in the dissolver under vacuum. Mixing was carried out with a PC Labor System Dissolver of LDV 0.3-1 type, as described under heading A3.

Hereby comparison reactive-resin component D3 containing comparison compound 2 as the backbone resin was obtained.

### D4. Production of Comparison Two-Component Reactive-Resin System D4

For production of the comparison two-component reactive-resin system D4, the comparison reactive-resin component D3 (component (A)) and the hardener component (component (B)) of the commercially available product HIT-HY 110 (Hilti Aktiengesellschaft; batch number: 1610264) were filled into a plastic canister (Ritter GmbH; volume ratio A:B=3:1) with inside diameters of 47 mm (component (A)) and respectively 28 mm (component (B)).

Hereby comparison two-component reactive-resin system D4 was obtained.

In order to demonstrate the influence of inventive compound (IV) on the viscosity of a reactive-resin master batch, of a reactive resin and of a reactive-resin component containing this as well as the influence on the bond strengths of a cured fastening caulk, the viscosities of the inventive reactive-resin master batches, reactive resins, reactive-resin components, the forces for extruding two-component reactive-resin systems as well as the bond strengths of cured fastening caulks were measured and respectively compared with the comparison formulations.

### Measurement of the Dynamic Viscosity of Reactive-Resin Master Batch A1 and of Comparison Master Batches C1 and D1

The dynamic viscosity of reactive-resin master batch A1 and of comparison reactive-resin master batches C1 and D1 (Table 1) was measured with a cone-and-plate measuring system according to DIN 53019. The diameter of the cone was 20 mm and the opening angle was 1°. The measurement was performed at a constant shear velocity of 100/s and the respective temperature (0, 5, 10, 15, 20, 30 and 40° C.). The measurement duration was 120 s and one measured point was generated every second. The shear velocity was attained at the respective temperature by a preceding ramp from 0 to 100/s over a duration of 30 s. Since Newtonian fluids are involved, a linear evaluation over the measurement portion was undertaken and the viscosity was determined with constant shear velocity of 100/s over the measurement portion. Respectively three measurements were made, wherein the respective mean values are indicated in Table 1.

### Measurement of the Dynamic Viscosity of the Reactive-Resin Components A3.1. B3.1. B3.2. B3.3 and B3.4 as Well as of Comparison Reactive-Resin Components C3.1. C3.3 and D3

The dynamic viscosity of the inventive reactive-resin component A3 and of comparison reactive-resin components C3 and D3 (Table 2) as well as of reactive-resin components B3.1, B3.2, B3.3 and B3.4 and of comparison reactive-resin components C3.3 (Table 3) was measured with using a plate/plate measuring system according to DIN 53019. The diameter of the plate was 20 mm and the gap distance was 3 mm. In order to prevent escape of the sample from the gap, a limiting ring of Teflon having a distance of 1 mm from the upper plate was used. The measurement temperature was 25° C. The method consisted of three portions: 1st Low shear, 2nd High shear, 3rd Low shear. During the 1st portion, shear was applied for 3 minutes at 0.5/s. In the 2nd portion, the shear velocity was increased logarithmically from 0.8/s to 100/s in 8 stages of 15 seconds each. These individual stages were: 0.8/s; 1.724/s; 3.713/s; 8/s; 17.24/s; 37.13/s; 80/s; 100/s. The 3rd portion was a repetition of the 1st portion. The viscosities were read at the end of each portion. The value of the second portion at 100/s is indicated in Table 2. Respectively three measurements were made, wherein the values indicated in Table 2 are the mean values of the three measurements.

First of all, the dynamic viscosity of reactive-resin master batch A1 containing comparison reactive-resin master batches C1 and D1 was compared at different temperatures (Table 1). The reactive-resin master batches respectively contained 65 wt % backbone resin and 35 wt % hydroxypropyl methacrylate.

TABLE 1
Results of the measurements of the dynamic viscosity of reactive-resin
master batch A1 and of comparison reactive-resin master batches C1
and D1 at different temperatures

| | | | Comparison |
|---|---|---|---|
| | Reactive-resin | Comparison reactive-resin | reactive-resin |
| | master batch | master batch | master batch |
| | A1 | C1 | D1 |
| T [° C.] | Viscosity [mPa · s] | | |
| 0 | 45,390 | 188,000 | 281.200 |
| 5 | 18,970 | 81,520 | 110,500 |
| 10 | 8,325 | 37,050 | 45,020 |
| 15 | 3,815 | 17,280 | 19.470 |
| 20 | 1,976 | 8,900 | 9,573 |
| 30 | 642 | 2,795 | 2,769 |
| 40 | 251 | 1,063 | 955 |

The measured results in Table 1 show that the inventive compounds cause a lowering of the dynamic viscosity, especially at low temperatures. Especially at temperatures below 20° C., the dynamic viscosity of the inventive reactive-resin master batches containing the inventive compound (IV) is lower than the dynamic viscosity of reactive-resin master batches C1 and D1, which contain comparison compounds 1 and 2.

Furthermore, the dynamic viscosity of reactive-resin component A3.1 produced from the inventive reactive-resin master batch A1 was compared with the dynamic viscosity of the reactive-resin components C3.1 and D3 produced from comparison reactive-resin master batches C1 and D1 (Table 2). All reactive-resin components from Table 2 contained 33 wt % of backbone resin in the reactive resin.

TABLE 2
Results of the measurements of the dynamic viscosity of reactive-resin
component A3.1 and of comparison reactive-resin components
C3.1 and D3

| | | Comparison | Comparison |
|---|---|---|---|
| | Reactive-resin | reactive-resin | reactive-resin |
| | component A3.1 | component C3.1 | component D3 |
| Dynamic | 11.3 | 13.9 | 12.8 |
| viscosity | | | |
| [Pa · s]; 25° C. | | | |

The measured results in Table 2 show that the inventive compounds also lead to lowering of the dynamic viscosity of the reactive-resin components containing them. The dynamic viscosity of the inventive reactive-resin component containing the inventive compound (IV) is lower than the dynamic viscosity of comparison reactive-resin components C3.1 and D3, which contain comparison compounds 1 and 2.

In order to show that, by use of the inventive compounds, it is possible with the example of compound (IV) to increase the proportion of backbone resin in the reactive resin and thus in the reactive-resin component, without hereby increasing the viscosity too much, and without increasing the extrusion forces too much, the dynamic viscosity of reactive-resin components containing different proportions of backbone resin was measured (Table 3).

TABLE 3
Results of the measurement of the dynamic viscosity of reactive-resin
components B3.1, B3.2, B3.3 and B3.4 as well as of comparison reactive-resin
component C3.3

| | | | | | Comparison |
|---|---|---|---|---|---|
| | Reactive-resin | Reactive-resin | Reactive-resin | Reactive-resin | reactive-resin |
| | component | component | component | component | component |
| | B3.1 | B3.2 | B3.3 | B3.4 | C3.3 |
| Proportion of | 37 wt % | 40 wt % | 45 wt % | 50 wt % | 37 wt % |
| backbone resin in | | | | | |
| reactive resin | | | | | |
| Dynamic | 7.4 | 8.8 | 11.7 | 15.1 | 12.5 |
| viscosity | | | | | |
| [Pa · s]; 25° C. | | | | | |

The results in Table 3 show that the dynamic viscosity of the reactive-resin component remains relatively low despite the increase of the proportion of backbone resin. Even an increase of the proportion of backbone resin to 45 wt % leads to a reactive-resin component that has a lower viscosity than the comparison reactive-resin component containing a backbone-resin proportion of 37 wt %.

Even at a backbone-resin proportion of 50 wt %, the viscosity of the reactive-resin component is only slightly higher than that of the comparison reactive-resin component containing a backbone-resin proportion of 37 wt %. At the same proportion of backbone resin in the reactive resin, the dynamic viscosity of the inventive reactive-resin component is much lower than that of the comparison reactive-resin component.

### Determination of the Extrusion Forces

For determination of the forces for extrusion of the reactive-resin systems, the canisters containing the respective reactive-resin components (component (A)) and hardener component (component (B)) were adjusted to temperatures of 0° C. and 25° C. respectively. Using a material-testing machine of the Zwick Co. with a load cell (test range up to 10 kN), the canisters were extruded via a static mixer (HIT-RE-M mixer; Hilti Aktiengesellschaft) with a constant speed of 100 mm/min over a path of 45 mm and the mean force developed in the process was measured.

The forces for extruding two-component reactive-resin system A4.1 as well as comparison two-component reactive-resin systems C4.1 and D4, which respectively contain a proportion of 33 wt % of backbone resin in the reactive resin, were measured at 0° C. and 25° C. (Table 4).

TABLE 4
Results of the measurement of the forces for extruding two-component
reactive-resin system A4.1 and comparison two-component reactive-resin
systems 04.1 and D4 at 0° C. and 25° C.

| | | | Comparison |
|---|---|---|---|
| | Two-component | Comparison | two-component |
| | reactive-resin | two-component | reactive-resin |
| | system | reactive-resin system | system |
| | A4.1 | C4.1 | D4 |
| Force [N] | 1322 | 1631 | 1639 |
| at 0° C. | | | |
| Force [N] | 1036 | 1151 | 1079 |
| at 25° C. | | | |

The forces for extruding two-component reactive-resin system B4.1 as well as comparison two-component reactive-resin system C4.3, which respectively contain a proportion of 37 wt % of backbone resin in the reactive resin, were measured at 0° C. and 25° C. (Table 5).

TABLE 5
Results of the measurement of the forces for extruding two-component
reactive-resin system B4.1 and comparison two-component reactive-resin
system C4.3 at 0° C. and 25° C.

| | Two-component | |
|---|---|---|
| | reactive-resin system | Comparison two-component |
| | B4.1 | reactive-resin system C4.3 |
| Force [N] | 579 | 700 |
| at 0° C. | | |
| Force [N] | 281 | 368 |
| at 25° C. | | |

The results in Tables 4 and 5 show that the forces for extruding the inventive two-component reactive-resin systems are lower both at 0° C. and at 25° C. than the forces for extruding the comparison two-component reactive-resin systems.

### Measurement of the Bond Strength

To determine the bond strengths (load ratings) of the cured fastening caulks, M12 threaded anchor rods were inserted into drilled holes in C20/25 concrete, which had a diameter of 14 mm and a drilled-hole depth of 72 mm and were filled with the reactive-resin mortar compositions. The bond strengths were determined by pulling out the threaded anchor rods centrally. Respectively five threaded anchor rods were set and the bond strength was determined after 24 hours of curing. The fastening caulks were extruded from the canisters and injected into the drilled holes via a static mixer (HIT-RE-M Mixer; Hilti Aktiengesellschaft).

The bond strength was determined under the following drilled-hole conditions:

A1: In a cleaned, dust-free, dry, drilled hole produced by hammer-drilling. Setting, curing and extraction took place at room temperature. The temperature of the two-component reactive-resin system or of the fastening caulks during setting was 20° C.
F1b′: In a half-cleaned (approximately 50% dust-free) wet drilled hole produced by hammer-drilling. Setting, curing and extraction took place at room temperature. The temperature of the two-component reactive-resin system or of the fastening caulks during setting was 20° C.
A21 (80° C.): In a cleaned, dust-free, dry, drilled hole produced by hammer-drilling. Setting and curing took place at room temperature. Thereafter the concrete and dowels were stored for 24 hours at 80° C. Extraction took place at 80° C. The temperature of the two-component reactive-resin system or of the fastening caulks during setting was 20° C.
A23 (−5° C.): In a cleaned, dust-free, dry, drilled hole produced by hammer-drilling. Setting, curing and extraction took place at −5° C. The temperature of the two-component reactive-resin system or of the fastening caulks during setting was 0° C.

The bond strengths (N/mm²) determined in this way are listed as the mean value of five measurements in the following Tables 6 and 7.

TABLE 6
Bond strengths measured under A1, F1b*, A23 and A21 conditions for the
fastening caulks from the two-component reactive-resin systems A4.1 and
A4.2 and for the comparison fastening caulk from comparison
two-component reactive-resin system C4.1

| | Bond strength [N/mm²] | | | |
|---|---|---|---|---|
| | A1 | F1b* | A23 (−5° C.) | A21 (80° C.) |
| Fastening caulk from A4.1 | 18.3 | 12.3 | 10.2 | 12.9 |
| containing 33 wt % backbone | | | | |
| resin in the reactive resin | | | | |
| Fastening caulk from A4.2 | 20.9 | 14.5 | 13.5 | 14.3 |
| containing 41 wt % backbone | | | | |
| resin in the reactive resin | | | | |
| Comparison fastening caulk | 20.3 | 13.0 | 11.6 | 11.9 |
| from C4.1 containing 33 wt % | | | | |
| backbone resin in the | | | | |
| reactive resin | | | | |

The results in Table 6 show that the bond strengths of the fastening caulk from A4.1, which has a backbone-resin proportion of 33 wt %, are approximately equal, under A1, F1b′ and A23 conditions, to the bond strengths of the comparison fastening caulk from C4.1. Under A21 conditions, the bond strengths of the fastening caulk from A4.1 are somewhat higher than the bond strengths of the comparison fastening caulk from C4.1. Furthermore, it is evident that an increase in the proportion of backbone resin also leads to an increase of the bond strength, as in the fastening caulk from A4.2.

This is also shown by the results in Table 7, wherein, with increasing backbone-resin proportion (B4.1→B4.4), an increase of the bond strengths was observed compared with the bond strength of the comparison fastening caulk from C4.3 (37 wt % backbone resin in the reactive resin).

TABLE 7
Results of the measurements of the bond strengths, measured under A1
conditions, for the fastening caulks from the two-component reactive-resin
systems B4.1 to B4.4 and for the comparison fastening caulk from
comparison two-component reactive-resin system C4.3

| | Fastening caulk comprising | | | | |
|---|---|---|---|---|---|
| | B4.1 | B4.2 | B4.3 | B4.4 | C4.3 |
| Proportion of | 37 wt % | 40 wt % | 45 wt % | 50 wt % | 37 wt % |
| backbone | | | | | |
| resin in the | | | | | |
| reactive resin | | | | | |
| Bond | 33.7 | 34.4 | 34.6 | 35.6 | 33.3 |
| strength | | | | | |
| [N/mm²] | | | | | |

Furthermore, reactive resins, reactive-resin components and two-component reactive-resin systems respectively containing the inventive compound (IV) as backbone resin were produced. The dynamic viscosity of the reactive resins and of the reactive-resin components were determined, as were the forces for extruding the two-component reactive-resin systems.

### Inventive Compound (V)

Furthermore, reactive resin master batches, reactive resins, reactive-resin components and two-component reactive-resin systems respectively containing the inventive compound (V) as backbone resin were produced. The dynamic viscosity of the reactive-resin master batches and of the reactive-resin components as well as the forces for extruding the two-component reactive-resin systems were determined and compared with the corresponding values for the comparison compositions.

### E1.1 Production of Reactive-Resin Master Batch E1 Containing 65 wt % of Compound (V) and 35 wt % of 1.4-Butanediol Dimethacrylate

80400 g Hydroxypropyl methacrylate (Visiomerr HPMA; Evonik Degussa GmbH) was first introduced into a 300-liter steel reactor with internal thermometer and stirrer shaft then 36 g phenothiazine (D Prills; Allessa Chemie), 70 g 4-hydroxy-2,2,6,6-tetramethyl-piperidinyl-1-oxyl (TEMPOL; Evonik Degussa GmbH) and 56 g dioctyltin dilaurate (TIB KAT® 216; TIB Chemicals) were added. The batch was heated to 60° C. Then 69440 g methylene-di(phenyl isocyanate) (MDI; Lupranat® MIS, BASF SE) was added dropwise with stirring within 1.5 hours. Thereafter stirring was continued for a further 45 minutes at 80° C. Then 50000 g 1,4-butanediol dimethacrylate (Visiomer 1,4-BDDMA, Evonik Degussa GmbH) was added.

Reactive-resin master batch E1.1 containing 75 wt % of compound (V) as backbone resin and 25 wt % of 1,4-butanediol dimethacrylate, relative to the total weight of the reactive-resin master batch, was obtained.

By dilution with 1,4-butanediol dimethacrylate, it was possible to dilute reactive-resin master batch E1.1 to the point that the master batch contained 65 wt % of compound (V) and 35 wt % of 1,4-butanediol dimethacrylate.

Compound (V) has the following structure:

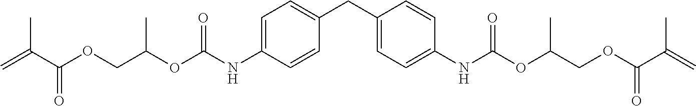 [SMILES: C=C(C)C(=O)OCC(C)OC(=O)Nc1ccc(Cc2ccc(NC(=O)OC(C)COC(=O)C(=C)C)cc2)cc1]

### E1.2 Production of the Inventive Reactive-Resin Master Batch E1.2 Containing 65 wt % of Compound (V and 35 wt % of Hydroxypropyl Methacrylate

1396 g Hydroxypropyl methacrylate (Visiomer HPMA 98; Evonik Degussa GmbH) was first introduced into a 2-liter glass laboratory reactor with internal thermometer and stirrer shaft then 0.3 g phenothiazine (D Prills; Allessa Chemie), 0.6 g 4-hydroxy-2,2,6,6-tetramethyl-piperidinyl-1-oxyl (TEMPOL; Evonik Degussa GmbH) and 0.48 g dioctyltin dilaurate (TIB KAT® 216; TIB Chemicals) were added. The batch was heated to 60° C. Then 602.6 g methylene-di(phenyl isocyanate) (MDI; Lupranat® MIS, BASF SE) was added dropwise with stirring (600 rpm) within 1.5 hours. Thereafter stirring was continued for a further 30 minutes at 80° C.

Hereby reactive-resin master batch E1.2 containing 65 wt % of compound (V) as backbone resin and 35 wt % hydroxypropyl methacrylate, relative to the total weight of the reactive-resin master batch, was obtained.

### E2. Production of Reactive Resin E2 Containing 45 wt % of Compound M

2520 g Reactive-resin master batch from E1.1 is mixed with 439.74 g hydroxypropyl methacrylate and 1128.54 g 1,4-butanediol dimethacrylate (1,4-BDDMA; Evonik Degussa GmbH). 96.6 g Di-isopropanol-p-toluidine (BASF SE), 13.44 g catechol (Catechol Flakes, RHODIA) and 5.88 g tert-Butylpyrocatechol (tBBK, CFS EUROPE S.p.A. (Borregaard Italia S.p.A.)) were added to this mixture and stirred until complete homogenization.

Hereby reactive-resin E2 containing 45 wt % of compound (V) as backbone resin was obtained.

### E3.1 Production of Reactive-Resin Component E3.1

(for measurement of the viscosity and of the extrusion forces at 23° C.)

2106 g Reactive resin E2 was mixed with 930.42 g Secar® 80 (Kemeos Inc.), 64.8 g Cab-O-Sil® TS-720 (Cabot Corporation), 90.72 g Aerosil® R 812 (Evonik Industries AG) and 2222.64 g quartz sand F32 (Quarzwerke GmbH) in the dissolver under vacuum, using a PC Labor System Dissolver of LDV 0.3-1 type. The mixture was stirred for 2 minutes at 2500 rpm and thereafter for 10 minutes at 4500 rpm under vacuum (pressure s 100 mbar) with a 55 mm dissolver disk and an edge scraper.

Hereby reactive-resin component E3.1 was obtained.

### E3.2 Production of Reactive-Resin Component E3.2

(for measurement of the viscosity at 0° C. and 25° C. and of the extrusion forces at 0° C.) 1053 g Reactive resin E2 was mixed with 465.21 g Secar® 80 (Kemeos Inc.), 27 g Cab-O-Sil® TS-720 (Cabot Corporation), 48.6 g Aerosil® R 812 (Evonik Industries AG) and 1111.32 g quartz sand F32 (Quarzwerke GmbH) in the dissolver under vacuum. Mixing was carried out with a PC Labor System Dissolver of LDV 0.3-1 type, as described under heading E3.1.

Hereby reactive-resin component E3.2 was obtained.

### E4. Production of Two Component Reactive-Resin Systems E4.1 and E4.2

For production of the two-component reactive-resin systems E4.1 and E4.2, respectively the reactive-resin components E3.1 and E3.2 (component (A)) and the hardener component (component (B)) of the commercially available product HIT-HY 200 (Hilti Aktiengesellschaft; batch number: 8104965) were filled into a plastic canister (Ritter GmbH; volume ratio A:B=5:1) with inside diameters of 32.5 mm (component (A)) and respectively 14 mm (component (B)).

Hereby the two-component reactive-resin systems E4.1 (for measurement of the extrusion forces at 23° C.) and E4.2 (for measurement of the extrusion forces at 0° C.) were obtained.

### Comparison Examples F and G

For comparison, reactive-resin master batches, reactive resins and reactive-resin components containing comparison compounds 1 and 2 two-were produced as follows.

### F1. Production of Comparison Reactive-Resin Master Batches F1.1 and F1.2

A comparison reactive-resin master batch containing 65 wt % of comparison compound 1 as backbone resin and 35 wt % 1,4-butanediol dimethacrylate (F1.1) or hydroxypropyl methacrylate (F1.2), respectively relative to the total weight of the reactive-resin master batch, was synthesized according to the method in EP 0 713 015 A1, which is included herewith as reference and to the entire disclosure of which reference is made.

The product (comparison compound 1) has an oligomer distribution, wherein the oligomer containing a repeat unit has the following structure:

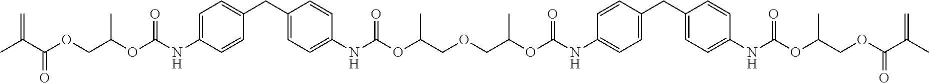

### F2. Production of Comparison Reactive Resin F2 Containing 45 wt % of Comparison Compound 1

830.76 g Comparison reactive-resin master batch F1.1 was mixed with 125.64 g hydroxypropyl methacrylate and 211.68 g 1,4-butanediol dimethacrylate (1,4-BDDMA; Evonik Degussa GmbH). 27.6 g Di-isopropanol-p-toluidine (BASF SE), 3.24 g catechol (Catechol Flakes, RHODIA) and 1.08 g tert-butylpyrocatechol (tBBK, CFS EUROPE S.p.A. (Borregaard Italia S.p.A.)) were added to this mixture and stirred until complete homogenization.

Hereby comparison reactive-resin F2 containing a 42 wt % proportion of comparison compound 1 as backbone resin was obtained.

### F3.1. Production of Comparison Reactive-Resin Component F3.1

(for measurement of the viscosity and of the extrusion forces at 23° C.)

1053 g Comparison reactive resin F2 was mixed with 465.21 g Secar® 80 (Kerneos Inc.), 32.4 g Cab-O-Sil® TS-720 (Cabot Corporation), 45.36 g Aerosil® R812 (Evonik Industries AG) and 1111.33 g quartz sand F32 (Quarzwerke GmbH) in the dissolver under vacuum.

Hereby comparison reactive-resin component F3.1 containing comparison compound 1 as the backbone resin was obtained.

### F3.2. Production of Comparison Reactive-Resin Component F3.2

(for measurement of the viscosity at 0° C. and 25° C. and of the extrusion forces at 0° C.)

1053 g Comparison reactive resin F2 was mixed with 465.21 g Secar® 80 (Kerneos Inc.), 27 g Cab-O-Sil® TS-720 (Cabot Corporation), 48.6 g Aerosil® R812 (Evonik Industries AG) and 1111.32 g quartz sand F32 (Quarzwerke GmbH) in the dissolver under vacuum.

Hereby comparison reactive-resin component F3.2 containing comparison compound 1 as the backbone resin was obtained.

### F4. Production of Comparison Two-Component Reactive-Resin Systems F4.1 and F4.2

For production of the two-component reactive-resin systems F4.1 and F4.2, respectively the reactive-resin components F3.1 and F3.2 (component (A)) and the hardener component (component (B)) of the commercially available product HIT-HY 200 (Hilti Aktiengesellschaft; batch number: 8104965) were filled into a plastic canister (Ritter GmbH; volume ratio A:B=5:1) with inside diameters of 32.5 mm (component (A)) and respectively 14 mm (component (B)).

Hereby the two-component reactive-resin systems F4.1 (for measurement of the extrusion forces at 23° C.) and F4.2 (for measurement of the extrusion forces at 0° C.) were obtained.

### G1. Production of Comparison Reactive-Resin Master Batches G1.1 and G1.2

Comparison reactive-resin master batches G1.1 and G1.2 respectively containing 65 wt % of reference compound 2 as backbone resin and 35 wt % 1,4-butanediol dimethacrylate (G1.1) or hydroxypropyl methacrylate (G1.2), respectively relative to the total weight of the reactive-resin master batch, were synthesized according to the method in EP 0 713 015 A1, which is included herewith as reference and to the entire disclosure of which reference is made.

Comparison compound 2 has the following structure:

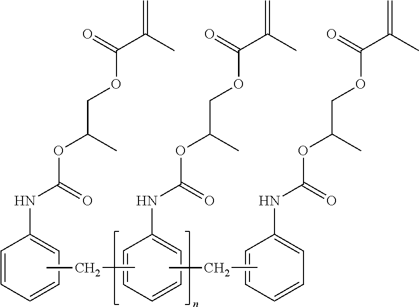

### G2. Production of Comparison Reactive Resin G2 Containing 45 wt % of Comparison Compound 2

830.76 g Reactive-resin master batch G1.1 was mixed with 125.64 g hydroxypropyl methacrylate and 211.68 g 1,4-butanediol dimethacrylate (1,4-BDDMA; Evonik Degussa GmbH). 27.6 g Di-isopropanol-p-toluidine (BASF SE), 3.24 g catechol (Catechol Flakes, RHODIA) and 1.08 g tert-butylpyrocatechol (tBBK, CFS EUROPE S.p.A. (Borregaard Italia S.p.A.)) were added to this mixture and stirred until complete homogenization.

Hereby comparison reactive-resin G2 containing a 45 wt % proportion of compound 2 as backbone resin in hydroxypropyl methacrylate and 1,4-butanediol dimethacrylate was obtained.

### G3.1. Production of Comparison Reactive-Resin Component G3.1

(for measurement of the viscosity and of the extrusion forces at 23° C.)

1053 g Comparison reactive resin G2 was mixed with 465.21 g Secar® 80, 32.4 g Cab-O-Sil® TS-720 (Cabot Corporation), 45.36 g Aerosil® R812 (Evonik Industries AG) and 1111.32 g quartz sand F32 (Quarzwerke GmbH) in the dissolver under vacuum.

Hereby comparison reactive-resin component G3.1 containing comparison compound 1 as the backbone resin was obtained.

### G3.2. Production of Comparison Reactive-Resin Component G3.2

(for measurement of the viscosity at 0° C. and 25° C. and of the extrusion forces at 0° C.)

1053 g Comparison reactive resin G2 was mixed with 465.21 g Secar® 80 (Kemeos Inc.), 27 g Cab-O-Sil® TS-720 (Cabot Corporation), 48.6 g Aerosil® R812 (Evonik Industries AG) and 1111.32 g quartz sand F32 (Quarzwerke GmbH) in the dissolver under vacuum.

Hereby comparison reactive-resin component G3.2 containing comparison compound 2 as the backbone resin was obtained.

### G4. Production of Comparison Two-Component Reactive-Resin Systems G4.1 and G4.2

For production of comparison two-component reactive-resin systems G4.1 and G4.2, respectively the reactive-resin components G3.1 and G3.2 (component (A)) and the hardener component (component (B)) of the commercially available product HIT-HY 200 (Hilti Aktiengesellschaft; batch number: 8104965) were filled into a plastic canister (Ritter GmbH; volume ratio A:B=5:1) with inside diameters of 32.5 mm (component (A)) and respectively 14 mm (component (B)).

Hereby the two-component comparison reactive-resin systems G4.1 (for measurement of the extrusion forces at 23° C.) and G4.2 (for measurement of the extrusion forces at 0° C.) were obtained.

In order to demonstrate the influence of inventive compound (V) on the viscosity of a reactive-resin master batch, of a reactive resin and of a reactive-resin component containing this, the viscosities of the inventive reactive-resin master batches, reactive resins, reactive-resin components as well as the forces for extruding reactive-resin systems were measured and respectively compared with the comparison formulations.

### Measurement of the Dynamic Viscosity of Reactive-Resin Master Batches E1.1 and E1.2 and of Comparison Master Batches F1.1. F1.2. G1.1 and G1.2

The dynamic viscosity of reactive-resin master batches E1.1 and E1.2 and of comparison reactive-resin master batches F1.1, F1.2, G1.1 and G1.2 (Table 8) was measured with a cone-and-plate measuring system according to DIN 53019. The diameter of the cone was 20 mm and the opening angle was 1°. The measurement was performed at a constant shear velocity of 100/s and the respective temperature (0, 5, 10, 15, 20, 30 and 40° C.). The measurement duration was 120 s and one measured point was generated every second. The shear velocity was attained at the respective temperature by a preceding ramp from 0 to 100/s over a duration of 30 s. Since Newtonian fluids are involved, a linear evaluation over the measurement portion was undertaken and the viscosity was determined with constant shear velocity of 100/s over the measurement portion. Respectively three measurements were made, wherein the corresponding mean values are indicated at the bottom of Table 8.

### Measurement of the Dynamic Viscosity of Reactive-Resin Component E3.1 as Well as of Comparison Reactive-Resin Components F3.1 and G3.1

The dynamic viscosity of reactive-resin component E3.1 and of comparison reactive-resin components F3.1 and G3.1 (Table 9) was measured with using a plate/plate measuring system according to DIN 53019. The diameter of the plate was 35 mm and the gap distance was 3 mm. In order to prevent escape of the sample from the gap, a limiting ring of Teflon having a distance of 1 mm from the upper plate was used. The measurement temperature was 23° C. The method consisted of two portions: 1. A ramp from 0/s to 10/s with a duration of 120 s and 100 measurement points. 2. Constant shear of 10/s for 180 s with 180 measurement points. A linear evaluation of the second portion was undertaken and the value was expressed as the viscosity. Respectively three measurements were made, wherein the corresponding mean values are indicated in Table 9.

### Measurement of the Dynamic Viscosity of Reactive-Resin Components E3.2 as Well as of Comparison Reactive-Resin Components F3.2 and G3.2

The dynamic viscosity of reactive-resin component E3.2 and of comparison reactive-resin components F3.2 and G3.2 (Table 10) was measured with a plate/plate measuring system according to DIN 53019. The diameter of the plate was 20 mm and the gap distance was 3 mm. In order to prevent escape of the sample from the gap, a limiting ring of Teflon having a distance of 1 mm from the upper plate was used. The measurement temperature was 0° C. and 25° C. respectively. The method consisted of three portions: 1st Low shear, 2nd High shear, 3rd Low shear. During the 1st portion, shear was applied for 3 minutes at 0.5/s. In the 2nd portion, the shear velocity was increased logarithmically from 0.8/s to 100/s in 8 stages of 15 seconds each. These individual stages were: 0.8/s; 1.724/s; 3.713/s; 8/s; 17.24/s; 37.13/s; 80/s; 100/s. The 3rd portion was a repetition of the 1st portion. The viscosities were read at the end of each portion. The values of the second portion at 8/s and 100/s are indicated in Table 10. Respectively three measurements were made, wherein the corresponding mean values are indicated in Table 10.

First of all, the dynamic viscosity of reactive-resin master batches E1.1 and E1.2 containing comparison reactive-resin master batches F1.1, F1.2, G1.1 and G1.2 was compared at different temperatures (Table 8). The reactive-resin master batches respectively contained 65 wt % backbone resin and 35 wt % hydroxypropyl methacrylate (E1.1, F1.1, G1.1) or 35 wt % 1,4-butanediol dimethacrylate (E1.2, F1.2, G1.2).

TABLE 8
Results of the measurements of the dynamic viscosity of reactive-
resin master batches E1.1 and E1.2 and of comparison reactive-resin
master batches F1.1, F1.2, G1.1 and G1.2 at different temperatures

| T | E1.2 | E1.1 | F1.2 | F1.1 | G1.2 | G1.1 |
|---|---|---|---|---|---|---|
| [° C.] | Dynamic viscosity [mPa · s] | | | | | |
| 40 | 283 | 301 | 952 | 599 | 961 | 1,147 |
| 30 | 736 | 737 | 2,897 | 1,579 | 2,877 | 3,139 |
| 20 | 2,356 | 2,159 | 11,045 | 5,045 | 10,745 | 10,475 |
| 15 | 4,716 | 4,104 | 24,505 | 10,051 | 23,240 | 21,145 |
| 10 | 10,270 | 8,387 | 59,360 | 21,480 | 54,960 | 45,855 |
| 5 | 24,150 | 18,435 | 156,750 | 49,575 | 137,250 | 106,650 |
| 0 | 62,355 | 43,800 | 438,800 | 123,350 | 339,950 | 265,200 |

The measured results show that the inventive reactive-resin master batches cause a lowering of the dynamic viscosity, especially at low temperatures. Especially at temperatures below 20° C., the dynamic viscosity of the inventive reactive-resin master batches containing compound (V) as backbone resin is much lower than the viscosity of comparison reactive-resin master batches containing compounds 1 and 2.

Furthermore, the dynamic viscosity of reactive-resin component E3.1 produced from inventive reactive-resin master batch E1.1 was compared with the dynamic viscosity of the comparison reactive-resin components F3.1 and G3.1 produced from comparison reactive-resin master batches F1.1 and G1.1 (Table 9). All reactive-resin components shown in Table 9 contained 45 wt % of backbone resin in the reactive resin.

TABLE 9
Results of the measurement of the dynamic viscosity of reactive-resin
component E3.1 and of comparison reactive-resin components F3.1
and G3.1

| | E3.1 | F3.1 | G3.1 |
|---|---|---|---|
| Dyn. viscosity | 22.9 | 26.3 | 32.5 |
| [Pa · s]; 23° C. | | | |

The results in Table 9 show that the dynamic viscosity of the reactive-resin component containing the inventive compound (V) is relatively low compared with the dynamic viscosity of the comparison reactive-resin components containing comparison compounds 1 and 2 respectively.

In order to rule out the possibility that the differences in the dynamic viscosity of the reactive-resin components are due to the silica composition used, the measurements were repeated with respectively changed proportions of silica (reactive-resin component E3.2 and comparison reactive-resin components F3.2 and G3.2) and at two different shear rates (8 s⁻¹ and 100 s⁻¹) and two temperatures (0° C. and 25° C.). The results are shown in Table 10.

TABLE 10
Results of the measurement of the dynamic viscosity
of reactive-resin component E3.2 and of comparison
reactive-resin components F3.2 and G3.2

| | E3.2 | F3.2 | G3.2 | E3.2 | F3.2 | G3.2 |
|---|---|---|---|---|---|---|
| | (25° C.) | (25° C.) | (25° C.) | (0° C.) | (0° C.) | (0° C.) |
| Shear rate | Dynamic viscosity [Pa · s] | | | | | |
| 8 s⁻¹ | 30.9 | 40.4 | 44.0 | 100.5 | 142.6 | 168.7 |
| 100 s⁻¹ | 8.3 | 11.2 | 13.2 | 36.4 | 49.6 | 61.2 |

The results in Table 10 show that, despite changed silica composition, the dynamic viscosity of reactive-resin component E3.2, which contains the inventive compound (V), is relatively low both at 0° C. and at 25° C. compared with the dynamic viscosity of comparison reactive-resin components F3.2 and G3.2, which contain comparison compounds 1 and 2 respectively.

### Determination of the Extrusion Forces

To determine the extrusion forces at 0° C. and 23° C., reactive-resin systems E4.1 as well as comparison reactive-resin systems F4.1 and G4 were adjusted to temperatures of 0° C. and 23° C. respectively. Using a material-testing machine of the Zwick Co. with a load cell (test range up to 10 kN), the canisters were extruded via a static mixer (HIT-RE-M mixer; Hilti Aktiengesellschaft) with a constant speed of 100 mm/min over a path of 45 mm and the mean force developed in the process was measured.

The forces for extruding two-component reactive-resin system E4.1 containing the inventive compound (V) were compared with the force for extruding the comparison two-component reactive-resin systems F.1 and G4.1, which contain comparison compounds 1 and 2 respectively, at 0° C. and at 23° C. The measured results are compiled in Table 11.

TABLE 11
Results of the measurement of the forces for extruding two-component
reactive-resin system E4.1 and comparison two-component reactive-resin
systems F4.1 and G4.1 at 0° C. and 23° C.

| | | | Comparison |
|---|---|---|---|
| | Two-component | Comparison | two-component |
| | reactive-resin | two-component | reactive-resin |
| | system | reactive-resin system | system |
| | E4.1 | F4.1 | G4.1 |
| Force [N] | 462.1 | 750.2 | 740.5 |
| at 0° C. | | | |
| Force [N] | 377.5 | 400.7 | 396.0 |
| at 23° C. | | | |

The results in Table 11 show that the two-component reactive-resin system containing the inventive compound (V) exhibits a lower extrusion force both at 0° C. and at 23° C. than do the comparison two-component reactive-resin systems containing comparison compounds 1 and 2 respectively, wherein the differences at 0° C. are particularly evident.

This proves that the inventive compounds lead to lowering of the viscosity of reactive-resin master batches and thus of the corresponding reactive resins. The reactive-resin components produced therefrom also have lowered viscosity, which is reflected in a reduction of the extrusion forces.

Besides the lowering of the viscosity, the use of the inventive compounds leads to an increase of the load ratings of the cured fastening caulks.

1: A compound of general formula (I) 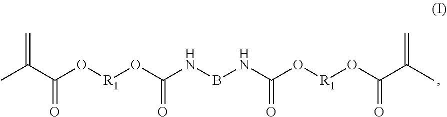
in which
B is an aromatic hydrocarbon group, and
each R₁, independently of one another, is a branched or linear aliphatic C₁-C₁₅ alkylene group.

2: The compound according to claim 1, wherein B is an aromatic C₆-C₂₀ hydrocarbon group.

3: The compound according to claim 2, wherein B contains one or two benzene rings, which optionally are substituted.

4: The compound according to claim 1, wherein R₁ is a C₂- or C₃-alkylene group.

5: A method for production of a reactive resin or of a reactive-resin component for construction purposes, the method comprising:
incorporating the compound according to claim 1 as a component of the reactive resin or reactive-resin component.

6: A method of lowering viscosity of a reactive resin for construction purposes, the method comprising:
incorporating the compound according to claim 1 in a reactive resin in need thereof.

7: A method of increasing the bond strength of a cured fastening caulk, the method comprising:
mixing the compound according to claim 1 as a component of a fastening caulk in need thereof.

8: A reactive resin, comprising:
the compound according to claim 1,
an inhibitor,
an accelerator, and
optionally a reactive diluent.

9: A reactive-resin component for a reactive-resin system, comprising:
the reactive resin according to claim 8.

10: A reactive-resin system, comprising:
the reactive-resin component (A) according to claim 9, and
a hardener component (B), which contains an initiator.

11: The reactive-resin system according to claim 10, wherein at least one of the components (A) or (B) contains an inorganic aggregate.

12: A method of preparing a reactive-resin system for construction, the method comprising:
combining a reactive-resin component (A) and a hardener component (B) containing an initiator, thereby obtaining the reactive resin system according to claim 10.

13: A method of chemical fastening of an anchor in a drilled hole, the method comprising:
chemically fastening an anchor in a drilled hole with the reactive-resin system of claim 10.

14: A method of reducing extrusion force of a reactive-resin component or a reactive-resin system for construction, the method comprising:
incorporating the compound according to claim 1 in a reactive-resin component in need thereof or in a reactive-resin system in need thereof.

15: The reactive resin of claim 8, wherein a proportion of the compound of general formula (I) in the reactive resin is from 25 wt % to 65 wt %.

16: The reactive-resin system of claim 10, having an extrusion force of from 462.1 to 1322 N at 0° C. and/or an extrusion force of from 281 to 1036 N at 25° C.

17. The method of claim 13, wherein a bond strength of the anchor in the drilled hole, chemically fastened with the reactive-resin system, is at least 10.2 N/mm².
